(19) United States
(12) Patent Application Publication
(10) Pub. No.: US 2003/0023427 A1
(43) Pub. Date: Jan. 30, 2003

(54) Devices, methods and a system for implementing a media content delivery and playback scheme

(76) Inventors: Lionel Cassin, Philadelphia, PA (US); Ronnen Miller, Philadelphia, PA (US); Luke A. Renn, Riverton, NJ (US); Donald A. Pellegrino, Philadelphia, PA (US); David J. Acquesta, Philadelphia, PA (US)

Correspondence Address: ARNOLD & PORTER, IP DOCKETING DEPARTMENT; RM 1126(b), 555 12TH STREET, N.W., WASHINGTON, DC, 20004-1206, US

(21) Appl. No.: 09/912,408

(22) Filed: Jul. 26, 2001

(51) Int. Cl. G10L 21/00

(52) U.S. Cl. 704/201

(57) ABSTRACT

Devices, methods and a system are provided for implementing a media content delivery and playback scheme, in which media content is delivered asynchronously via a communication channel to facilitate playback of the media content via a remote device.

### REFERENCE TO COMPACT DISC APPENDIX

A compact disc appendix including a computer program listing is filed herewith. The compact disc appendix includes the computer source code of a preferred embodiment of the present invention. Other embodiments of the present invention may be implemented using other computer code, using dedicated electronic hardware, using a combination of these, or otherwise. The contents of the compact disc appendix are incorporated herein in their entirety and are to be considered to be part of the disclosure of this specification, the files, dates of creation and size in bytes of each file are listed in FIGS. 11-23.

### BACKGROUND OF THE INVENTION

1. Field of the Invention

The present invention relates to the distribution of media content. In particular, the present invention relates to devices, methods and a system for implementing a media content delivery and playback scheme. The present invention provides for the delivery of media content asynchronously via a communication channel to facilitate playback of the media content through a remote device.

2. Description of Related Art

A conventional system for the delivery of media content may utilize media streaming, a technique whereby media content is delivered to a remote device in small segments. Each of the segments is stored in a buffer until there are a sufficient number of segments stored within the buffer to provide the user of the remote device with the opportunity to playback the media content in what appears to the user to be in a continuous stream. However, if there are problems with delivering the media content over the network, the playback of the media content may be disrupted. A conventional system is disclosed in U.S. Pat. No. 5,917,835 to Progressive Networks, Inc., which is incorporated herein by reference. This system has been marketed under the trade name “REAL AUDIO” ®.

### SUMMARY OF THE INVENTION

The principal advantage of the present invention is the provision of devices, methods and a system for implementing a media content delivery and playback scheme.

According to a first embodiment of the present invention, a device is provided including a processor that controls asynchronous delivery of media content over a communication channel to facilitate playback of the media content through a remote device. The playback of the media content is enabled at a predetermined time after the delivery of the media content.

According to one aspect of the first embodiment, the device may deliver the media content. According to another aspect of the first embodiment, the communication channel includes a satellite communication channel. According to yet another aspect of the first embodiment, the device may be a server computer. According to still another aspect of the first embodiment, the delivery of the media content may be controlled in accordance with a digital rights management scheme. According to yet another aspect of the first embodiment, the remote device may include a client computer. According to yet another aspect of the first embodiment, the remote device may be a portable device. In addition, the portable device may be a wireless device, such as a cellular phone.

According to a second embodiment of the present invention, a device is provided including a processor that controls asynchronous delivery of media content over a communication channel including a satellite system to facilitate playback of the media content through a remote device. The playback of the media content is enabled at a predetermined time after the delivery of the media content.

According to a third embodiment of the present invention, a device is provided including a processor executing software instructions including a software module. The software module includes a software delivery module that controls asynchronous delivery of media content over a communication channel to facilitate playback of the media content through a remote device. The playback of the media content is enabled at a first predetermined time after the delivery of the media content.

According to one aspect of the third embodiment, the device may deliver the media content. According to another aspect of the present invention, the device may be a server computer. According to another aspect of the present invention, the device also includes a memory portion that stores at least a portion of the software module.

According to still another aspect of the third embodiment, the software delivery module generates indicator data for the remote device that provide an indication of a second predetermined time when the media content will be delivered to the remote device. The device delivers the media content to the remote device at the second predetermined time. According to still yet another aspect of the third embodiment, the remote device initiates a session with the software delivery module not prior to the second predetermined time. According to yet another aspect of the present invention, the remote device initiates the session by making a request for a connection with the device. The device may establish the connection in response to the request. The device then provides the remote device with an indication that a user of the remote device is entitled to the media content. The remote device then accepts the media content for delivery unless the remote device already has the media content.

According to yet another aspect of the third embodiment, the software module may also include a software recovery module, which provides control information to the software delivery module to enable the automatic delivery of disrupted data without delivering data that has already been successfully delivered to the remote device.

According to still yet another aspect of the third embodiment, the software module may also include a software database interface module that processes requests to retrieve information from a database including media content information related to the media content. The software database interface module may receive a request for the information from the remote device, submit the request to the database, receive the information from the database, and send the information to the remote device. The software database interface module may also receive a request for the information from the software delivery module, submit the request to the database, receive the information, and send the information to the software delivery module to facilitate the delivery of the media content to the remote device.

According to yet another aspect of the third embodiment, the media content information may include at least an identifier identifying a media category with which the media content is associated. The media category may be a segment of an episode, an episode, a series, or a package with which the media content is associated. The package may be defined in accordance with user statistical information related to media usage by a user employing the remote device. The software delivery module may control the delivery of the media content based on user statistical information concerning media usage by a user employing the remote device.

According to yet another aspect of the third embodiment, the software delivery module may control the delivery of the media content in segments, each having a size which depends on the user statistical information.

According to still yet another aspect of the third embodiment, the software module may also include a software user interface module that processes requests for the information from a user of the remote device and submits the requests for the information to the software database interface module for retrieval from the database. The software user interface module may include a graphical user interface. The graphical user interface may be implemented via a web site.

According to yet another aspect of the third embodiment, the software module may also include a software storage module that facilitates the storage of media content in a media content repository by a content provider.

According to still yet another aspect of the third embodiment, the software database interface module may receive a request for the information from the software storage module, submit the request to the database, receive the information from the database, and send the information to the software storage module to facilitate storage of the media content in the media content repository.

According to yet another aspect of the third embodiment, the software module may also include a software content provider interface module that processes requests for the information from a content provider and submits the requests for the information to the software database interface module for retrieval from the database. The software content provider interface module may include a graphical user interface. The graphical user interface may be implemented via a web site.

According to a fourth embodiment of the present invention, a device is provided that includes a processor that controls playback of media content delivered asynchronously over a communication channel by a remote device. The playback of the media content is enabled at a predetermined time after the delivery of the media content.

According to one aspect of the fourth embodiment, the media content is not detectable by a user of the device until the predetermined time.

According to another aspect of the fourth embodiment, the processor may control the playback of media content via a display.

According to yet another aspect of the fourth embodiment, the device may include a display and the processor may control the playback of media content via the display.

According to still yet another aspect of the fourth embodiment, the device may be a computer, such as a client computer. In addition, the communication channel may include a network and the computer may be coupled to the remote device via the network.

According to still yet another aspect of the fourth embodiment, the device may be a portable device. The device may also be a wireless device, such as a cellular phone. In addition, the wireless device may include a display and the processor may control the playback of media content via the display.

According to a fifth embodiment of the present invention, a device is provided having a processor executing software instructions including a software module. The software module includes a first software playback module that controls the playback of media content delivered asynchronously over a communication channel by a remote device, wherein the playback of the media content is enabled at a predetermined time after the delivery of the media content.

According to a first aspect of the fifth embodiment, the media content is not detectable by a user of the device until the predetermined time.

According to another aspect of the fifth embodiment, the delivery of media content may be controlled in accordance with a digital rights management scheme.

According to another aspect of the fifth embodiment, the communication channel may include a satellite communication channel.

According to another aspect of the fifth embodiment, the first software playback module may control the playback of media content via a display. According to another aspect of the fifth embodiment, the device may include a display and the first software playback module controls the playback of media content via the display. According to still another aspect of the fifth embodiment, the first software playback module may include a graphical user interface through which the media content is displayed on the display.

According to another aspect of the fifth embodiment, the media content is not detectable by a user of the device until the predetermined time.

According to still yet another aspect of the fifth embodiment, the software module may also include a first software coordination module that coordinates the exchange of information with the remote device. The information includes the media content. In addition, the information may also include user statistical information related to media usage by a user employing the device. According to still another aspect of the fifth embodiment, the user statistical information may be sent by the device to the remote device to facilitate the delivery of the media content to the device.

According to another aspect of the fifth embodiment, the device may include a storage area that stores media data including the media content. The media data may include a number of media files, and the media content may be formed from a number of media files in accordance with at least one predefined rule. In addition, at least one of the number of media files may be used to form distinct media content.

According to still yet another aspect of the fifth embodiment the software module may also include a first registration module that receives user information from a user of the device. The device may also transmit the user information to the remote device to facilitate the delivery of the media content to the device.

According to another aspect of the fifth embodiment, the playback of media content is controlled based on user input. In addition, the user input may be provided to the device using a remote control device which communicates with the device. The remote control device may communicate with the device using infrared radiation.

According to still yet another aspect of the fifth embodiment, the software module may also include a voice recognition software module, which receives user input in the form of voice commands. The voice recognition software module converts the voice commands into electronic data and provides the first software playback module with the electronic data to facilitate the playback of media content.

According to sixth embodiment of the present invention, a device is provided having a processor that controls playback of media content delivered asynchronously from a remote device. The device generates a notification for a user of the device upon receipt of the media content. The notification may be an automatic notification, an audio notification, or an e-mail, for example. According to another aspect of the sixth embodiment, the playback of the media content is enabled at a predetermined time after the delivery of the media content.

According to a seventh embodiment of the present invention, a device is provided including a processor that controls playback of media content delivered asynchronously over a communication channel including a satellite system by a remote device. The playback of the media content is enabled at a predetermined time after the delivery of the media content.

According to an eighth embodiment of the present invention, a system is provided for implementing a media content delivery and playback scheme. The system includes a communication channel, a first device and a second device. The first device is coupled to the communication channel and includes a first processor that controls asynchronous delivery of media content over the communication channel. The second device is coupled to the communication channel and includes a second processor that controls the playback of media content delivered asynchronously over the communication channel by the first device, wherein the playback of media content is enabled in the second device at a first predetermined time after the delivery of the media content.

According to one aspect of the eighth embodiment, the media content is not detectable by a user of the second device until the predetermined time.

According to another aspect of the eighth embodiment, the second device may initiate a session with the first device at the predetermined time. The second device may initiate the session by making a request for a connection with the first device. The first device establishes the connection in response to the request. According to another aspect of the eighth embodiment, the first device provides the second device with an indication that a user of the second device is entitled to the media content. The second device may accept the media content for delivery only if it does not already have the media content.

According to another aspect of the eighth embodiment the first device may be a server computer and the second device may be a client computer.

According to another aspect of the eighth embodiment, the communication channel may include at least a portion of a network, such as a local area network or a wide area network. In addition, the communication channel may include at least a portion of the Internet.

According to another aspect of the eighth embodiment, the second device may be a portable device. The portable device may be a wireless device, such as a cellular phone.

According to another aspect of the eighth embodiment communication channel includes a wireless network.

According to another aspect of the eighth embodiment, the delivery of the media content from the first device to the second device is controlled in accordance with a digital rights management scheme.

According to a ninth embodiment of the present invention, a device is provided having a processor that controls the delivery of media content over a communication channel to a remote device in one of a first mode and a second mode. In the first mode, the processor controls the asynchronous delivery of media content over the communication channel to facilitate playback of the media content through the remote device. In the second mode, the processor controls the synchronous delivery of media content over the communication channel to facilitate the playback of the media content through the remote device.

According to a first aspect of the ninth embodiment, the playback of the media content is enabled at a predetermined time after the delivery of the media content.

According to another aspect of the ninth embodiment, the device delivers the media content.

According to another aspect of the ninth embodiment, the communication channel includes a satellite communication channel.

According to another aspect of the ninth embodiment, the device is a server computer.

According to another aspect of the ninth embodiment, the playback of the media content is controlled in accordance with a digital rights management scheme.

According to another aspect of the ninth embodiment, the remote device may include a client computer. The remote device may be a portable device, such as a wireless device. The wireless device may be a cellular phone.

According to a tenth embodiment of the present invention, a device is provided having a processor that controls playback of media content delivered over a communication channel by a remote device. The processor controls the playback of media content in one of a first mode and a second mode. In the first mode, the processor controls the playback of media content delivered asynchronously by the remote device. In the second mode, the processor controls the playback of media content delivered synchronously by the remote device.

According to a first aspect of the tenth embodiment, the playback of the media content is enabled at a predetermined time after the delivery of the media content.

According to another aspect of the tenth embodiment, the media content is not detectable by a user of the device until the predetermined time.

According to an eleventh embodiment of the present invention, a device is provided having a processor that controls the delivery of media content over a communication channel to a remote device in one of a first mode and a second mode. In the first mode, the processor controls the unicast-based delivery of media content over the communication channel to facilitate playback of the media content through the remote device. In the second mode, the processor controls the multicast-based delivery of media content over the communication channel to facilitate the playback of the media content through the remote device.

According to another aspect of the eleventh embodiment, the playback of the media content is enabled at a predetermined time after the delivery of the media content.

According to another aspect of the eleventh embodiment, the device may deliver the media content.

According to another aspect of the eleventh embodiment, the communication channel includes a satellite communication channel.

According to another aspect of the eleventh embodiment, the device may be a server computer.

According to another aspect of the eleventh embodiment, the playback of the media content may be controlled in accordance with a digital rights management scheme.

According to another aspect of the eleventh embodiment, the remote device may include a client computer. In addition, the remote device may be a portable device, such as a wireless device. The wireless device may be a cellular phone.

According to a twelfth embodiment of the present invention, a device is provided having a processor that controls playback of media content delivered over a communication channel by a remote device. The processor controls the playback of media content in one of a first mode and a second mode. In the first mode, the processor controls the playback of media content delivered by the remote device via a unicast mode of delivery. In the second mode, the processor controls the playback of media content delivered by the remote device via a multicast mode of delivery.

According to a first aspect of the twelfth embodiment, the playback of the media content is enabled at a predetermined time after the delivery of the media content.

According to another aspect of the twelfth embodiment, the media content is not detectable by a user of the device until the predetermined time.

According to a thirteenth embodiment of the present invention, a device is provided having a processor that controls asynchronous delivery of media content over a communication channel to facilitate playback of the media content through a remote device. The device receives a request for a connection from the remote device, establishes the connection in response to the request, provides the remote device with a first indication that a user of the remote device is entitled to the media content, and receives from the remote device a second indication that the remote device will accept the media content for delivery unless the remote device already has the media content.

According to a first aspect of the thirteenth embodiment, the first indication includes a first list of a first group of media content items including at least a first media content item, which is the media content.

According to another aspect of the thirteenth embodiment, the second indication includes a second list of a second group of media content items including at least a second media content item, which is the media content. The second group of media content items includes a number of media content items including at least the second media content item. The second group of media content items is a group of media content items that the remote device will accept for delivery from the device.

According to a fourteenth embodiment of the present invention, a device is provided having a processor that controls playback of media content delivered asynchronously over a communication channel by a remote device. The device makes a request for a connection to the remote device, receives a connection from the remote device in response to the request, receives a first indication from the remote device that a user of the device is entitled to the media content from the remote device, and provides a second indication to the remote device that the device will accept the media content for delivery unless the device already has the media content.

According to a first aspect of the fourteenth embodiment, the first indication includes a first list of a first group of media content items including at least a first media content item, which is the media content.

According to another aspect of the fourteenth embodiment, the second indication includes a second list of a second group of media content items including at least a second media content item, which is the media content. The second group of media content items includes a number of media content items including at least the second media content item. The second group of media content items is a group of media content items that the device will accept for delivery from the remote device.

According to a fifteenth embodiment of the present invention, a device is provided having a processor that controls playback of media content delivered asynchronously over a communication channel by a remote device. The device is capable of providing an indication to another on behalf of a user of the device, the indication being of a location where the media content may be found.

According to a sixteenth embodiment of the present invention, a device is provided having a processor that controls playback of media content delivered asynchronously over a communication channel by a remote device. The device is capable of providing a portion of the media content to another on behalf of a user of the device. The portion of the media content may be provided as an attachment to an e-mail.

According to an seventeenth embodiment of the present invention, a computer program product is provided for use in a device having a processor for executing software instructions. The computer program product includes a computer usable medium having computer readable program code means embodied therein for causing the device to control the asynchronous delivery of media content over a communication channel to facilitate playback of the media content through a remote device. The playback of the media content is enabled at a first predetermined time after the delivery of the media content.

According to a eighteenth embodiment of the present invention, a computer program product is provided for use in a device having a processor for executing software instructions. The computer program product includes a computer usable medium having computer readable program code means embodied therein for causing the device to control playback of media content delivered asynchronously over a communication channel by a remote device. The playback of the media content is enabled at a predetermined time after the delivery of the media content.

According to a nineteenth embodiment of the present invention, a method of implementing a media content delivery and playback scheme is provided. The method includes the step of delivering media content asynchronously via a communication channel for remote playback of the media content. The remote playback of the media content is enabled at a predetermined time after the delivery of the media content.

According to a first aspect of the nineteenth embodiment, the media content is not detectable until the predetermined time.

According to another aspect of the nineteenth embodiment, the method also includes the steps of receiving the media content; and enabling the playback of the media content at the predetermined time.

According to another aspect of the nineteenth embodiment, the method also includes the step of conducting the playback of the media content after enabling the playback of the media content at the predetermined time.

According to another aspect of the nineteenth embodiment, the step of conducting may include the step of displaying the media content.

According to a twentieth embodiment of the present invention, a method of implementing a media content delivery and playback scheme is provided. The method includes the steps of receiving media content which is delivered asynchronously via a communication channel; and enabling playback of the media content at a predetermined time after the receipt of the media content. According to a first aspect of the twentieth embodiment, the method includes the step of detecting the media content at the predetermined time.

According to another aspect of the twentieth embodiment, the method includes the step of providing a notification of receipt of the media content.

It is to be understood that both the foregoing general description and the following detailed description are exemplary and explanatory and are intended to provide further explanation of the invention as claimed.

### BRIEF DESCRIPTION OF THE DRAWINGS

These and other features, aspects and advantages of the present invention will become better understood with reference to the following description, appended claims, and accompanying drawings, in which:

FIG. 1 depicts a system for implementing a media content delivery and playback scheme in accordance with an embodiment of the present invention.

FIG. 2 depicts the components of a software module that may be employed in a first device in accordance with an embodiment of the present invention.

FIG. 3 depicts the components of a software module that may be employed in a second device in accordance with an embodiment of the present invention.

FIG. 4 depicts a flow chart featuring the steps of an embodiment of the present invention.

FIG. 5 depicts another flow chart featuring the steps of another embodiment of the present invention.

FIG. 6 depicts a system in accordance with a preferred embodiment of the present invention.

FIG. 7a depicts an aspect of a graphical user interface of a software playback module employed in a client computer of the system depicted in FIG. 6.

FIG. 7b depicts another aspect of the graphical user interface shown in FIG. 7a.

FIG. 8 depicts a protocol for communications between a client computer and a server computer in the system depicted in FIG. 6.

FIG. 9 depicts another protocol for communications between a client computer and a server computer in the system depicted in FIG. 6.

FIG. 10 depicts classes of objects and their corresponding attributes for objects stored in a database of the system depicted in FIG. 6.

FIGS. 11 through 23 depict the files, dates of creation, and size in bytes of the compact disc appendix.

### DETAILED DESCRIPTION OF THE PREFERRED EMBODIMENTS

The present invention is directed to devices, methods and a system for implementing a media content delivery and playback scheme. In particular, the present invention provides for the delivery of media content (including, for example, audio and video) asynchronously via a network to facilitate playback of the media content through a remote device (e.g., user-owned, client computer). The invention is implemented through the asynchronous delivery of media content by proactively storing media content to a remote device. However, the present invention may also support two modes of delivery: an asynchronous mode and a synchronous mode. Preferably, the delivery of media content is based on a user-generated content preference.

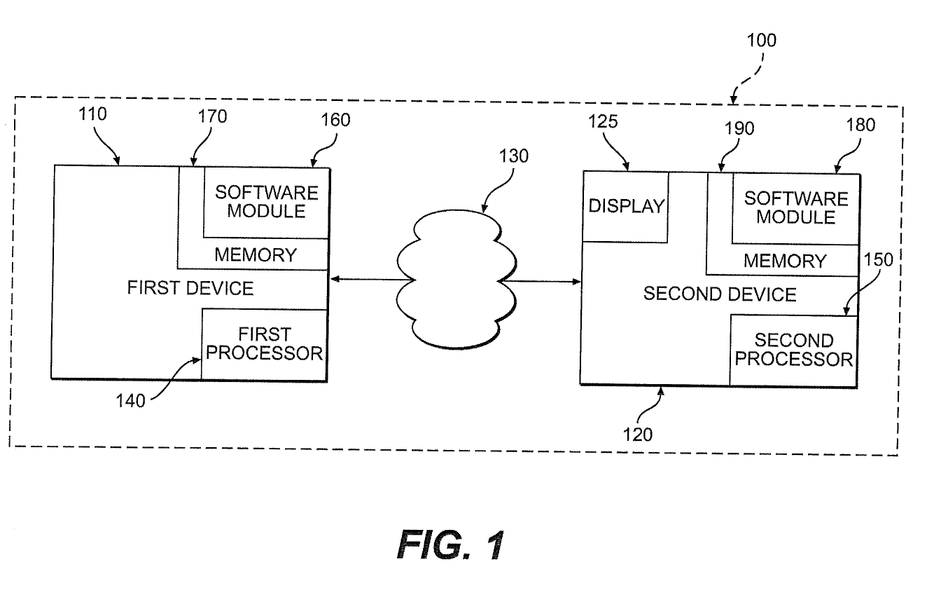

FIG. 1 shows a system 100, which implements a media content delivery and playback scheme in accordance with the present invention. The system 100 includes a first device 110 and a second device 120 coupled by a communication channel 130. The first device 110 and the second device 120 may be implemented in computer systems (not shown), which include those devices 110 and 120. The first device 110 is coupled to the communication channel 130 and includes a first processor 140 that controls asynchronous delivery of media content over the communication channel 130. The second device 120 is coupled to the communication channel 130 and includes a second processor 150 that controls the playback of media content delivered asynchronously over the communication channel 130 by the first device 110 (or a device controlled by the first device 110).

The playback of media content is enabled in the second device 120 at a first predetermined time after the delivery of the media content. In addition, the media content may not be detectable by a user of the second device 120 until the predetermined time. Preferably, the delivery of media content from the first device 110 (or a device controlled by the first device 110) to the second device 120 is controlled in accordance with a digital rights management scheme.

The devices 110 and 120 of the system 100 may, for example, operate in the following manner. The second device 120 may initiate a session with the first device 110 at the predetermined time. The second device 120 initiates the session by making a request for a connection with the first device 110. The first device 110 establishes the connection in response to the request. The first device 110 provides the second device with an indication that a user of the second device 120 is entitled to the media content. The second device 120 may accept the media content for delivery only if it does not already have the media content.

In the system 100, the first device 110 may be a server computer and the second device 120 may be a client computer. However, the system may be operated as a peer-to-peer system, in which either the first device 110 or the second device 120 operates as a server with respect to the other, which operates as the client. The first device 110 and/or the second device 120 may be a portable device. The portable device may be a wireless device, such as a cellular phone with or without a display.

The processor 150 of the second device 120 may control the playback of media content via a display. By way of example, the second device 120 may have associated with it a display 125 and the second processor 150 may control the playback of media content via the display 125. Although the display 125 is shown as being part of the device 120, the display 125 may be coupled to the device 120.

The communication channel 130 may include at least a portion of a network, such as a local area network, wide area network, public network (e.g., the Internet), a wireless network, or a combination of networks. The communication channel 130 may also include a satellite communication channel, including a satellite communication system. If the communication channel 130 includes at least part of a network, the first device 110 and the second device 120 may be coupled to each other via the network. In addition, if the communication channel 130 utilizes a satellite communication system, a satellite communication system may be used in the system 100 which is similar to those featured in U.S. Pat. Nos. 6,016,388 and 6,205,473, which are incorporated herein by reference.

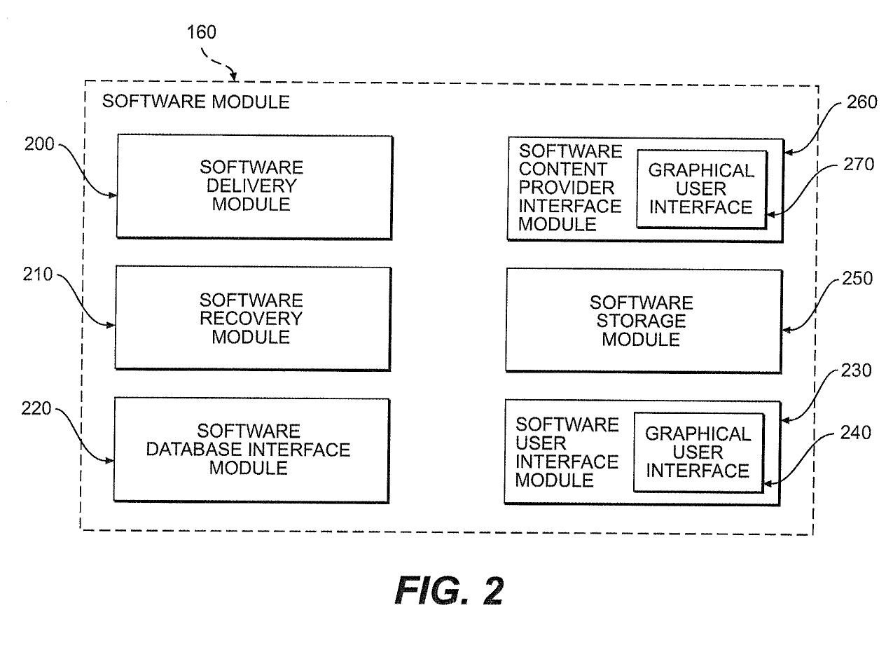

As noted above, the first device 110 includes a processor 140 that controls asynchronous delivery of media content over a communication channel to facilitate playback of the media content through a remote device (e.g., the second device 120). The processor 140 executes software instructions, which, in accordance with one embodiment of the present invention, may include a software module 160, as shown in FIGS. 1 and 2. The first device 110 may also include a memory portion 170 that stores at least a portion of the software module.

The software module 160 includes a software delivery module 200 that controls asynchronous delivery of media content over a communication channel to facilitate playback of the media content through the remote device. The playback of the media content is enabled at a first predetermined time after the delivery of the media content.

The software delivery module 200 may, for example, generate indicator data for the remote device that provide an indication of a second predetermined time when the media content will be delivered to the remote device. The first device 110 delivers the media content to the remote device at the second predetermined time. As noted above, the remote device may initiate a session with the software delivery module just prior to the second predetermined time. The remote device initiates the session by making a request for a connection with the first device 110. The first device 110 may establish the connection in response to the request. The first device 110 then provides the remote device with an indication that a user of the remote device is entitled to the media content. The remote device then accepts the media content for delivery unless the remote device already has the media content.

The software module 160 may also include a software recovery module 210, which provides control information to the software delivery module 200 to enable the automatic delivery of disrupted data without delivering data that has already been successfully delivered to the remote device.

The software module 160 may also include a software database interface module 220 that processes requests to retrieve information from a database (not shown) including media content information related to the media content. The software database interface module 220 may receive a request for the information from the remote device, submit the request to the database, receive the information from the database, and send the information to the remote device. The software database interface module 220 may also receive a request for the information from the software delivery module 200, submit the request to the database, receive the information, and send the information to the software delivery module 200 to facilitate the delivery of the media content to the remote device.

The media content information may include at least an identifier identifying a media category with which the media content is associated. The media category may be a segment of an episode, an episode, a series, or a package with which the media content is associated. The package may be defined in accordance with user statistical information related to media usage by a user employing the remote device. The software delivery module 200 may control the delivery of the media content based on user statistical information concerning media usage by a user employing the remote device. The software delivery module 200 may control the delivery of the media content in segments, each having a size that depends on the user statistical information.

The software module 160 may also include a software user interface module 230 that processes requests for the information from a user of the remote device and submits the requests for the information to the software database interface module 220 for retrieval from the database. The software user interface module 230 may include a graphical user interface 240. The graphical user interface 240 may be implemented via a web site.

The software module 160 may also include a software storage module 250 that facilitates the storage of media content in a media content repository (not shown) by a content provider. The software database interface module 220 may receive a request for the information from the software storage module 250, submit the request to the database, receive the information from the database, and send the information to the software storage module 250 to facilitate storage of the media content in the media content repository.

The software module 160 may also include a software content provider interface module 260 that processes requests for the information from a content provider and submits the requests for the information to the software database interface module 220 for retrieval from the database. The software content provider interface module 260 may include a graphical user interface 270. The graphical user interface 270 may be implemented via a web site.

The software module 160 described above in connection with the first device 110 may be stored on a computer program product in accordance with the present invention. By way of example, the computer program product includes a computer usable medium having computer readable program code means embodied therein for causing the first device 110 to control the asynchronous delivery of media content over a communication channel to facilitate playback of the media content through a remote device (e.g., the second device 120). The playback of the media content is enabled at a first predetermined time after the delivery of the media content.

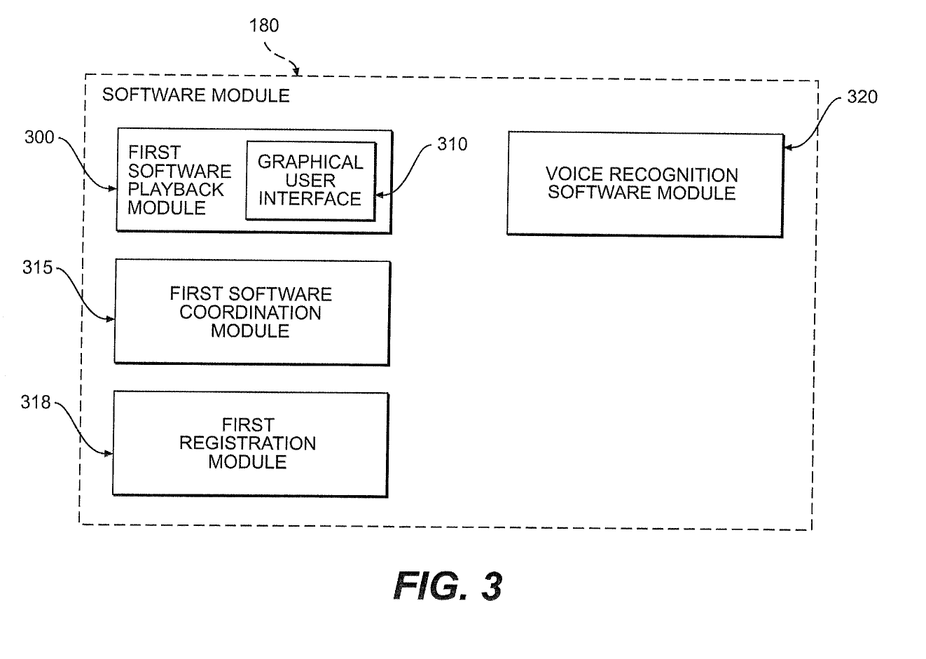

As noted above, the second device 120 includes a processor 150 that controls playback of media content delivered asynchronously over a communication channel by a remote device (e.g., the first device 110). The processor 150 executes software instructions, which, in accordance with one embodiment of the present invention, may include a software module 180, as shown in FIGS. 1 and 3. The second device 120 may also include a memory portion 190 that stores at least a portion of the software module 180.

The software module 180 includes a first software playback module 300 that controls the playback of media content delivered asynchronously over a communication channel by a remote device, wherein the playback of the media content is enabled at a predetermined time after the delivery of the media content. In addition, the media content may not be detectable by a user of the second device 120 until the predetermined time.

The media content may be distributed from the second device to another device (e.g., portable device). The distribution of the media content may be controlled in accordance with a digital rights management scheme, as set forth below.

The first software playback module 300 may control the playback of media content via a display. As noted above, the second device 120 may include a display 125 and the first software playback module 300 may control the playback of media content via the display 125. The first software playback module 300 may include a graphical user interface 310 through which the media content is displayed on the display 125.

The software module 180 may also include a first software coordination module 315 that coordinates the exchange of information with the remote device. The information includes the media content. In addition, the information may also include user statistical information related to media usage by a user employing the second device 120. The user statistical information may be sent by the second device 120 to the remote device to facilitate the delivery of the media content to the second device 120.

The second device 120 may include a storage area (not shown) that stores media data including the media content. The media data may include a number of media files, and the media content may be formed from a number of media files in accordance with at least one predefined rule. In addition, at least one of the number of media files may be used to form distinct media content.

The software module 180 may also include a first software registration module 318 that receives user information from a user of the second device 120. The second device 120 may also transmit the user information to the remote device to facilitate the delivery of the media content to the second device 120.

The playback of media content is controlled based on user input. In addition, the user input may be provided to the second device 120 using a remote control device (not shown) that communicates with the device. The remote control device may communicate with the device using infrared radiation in a manner well known in the art.

The software module 180 may also include a voice recognition software module 320, which receives user input in the form of voice commands. The voice recognition software module 320 converts the voice commands into electronic data and provides the first software playback module 300 with the electronic data to facilitate the playback of media content. Several voice recognition techniques which are known to those skilled in the art, may be implemented in the voice recognition software module 320. Examples of such voice recognition techniques are featured in U.S. Pat. Nos. 6,094,635, 6,154,722, and 6,260,012, which are incorporated herein by reference.

The software module 180 described above in connection with the second device 120 may be stored on a computer program product in accordance with present invention. By way of example, the computer program product may include a computer usable medium having computer readable program code means embodied therein for causing the second device 120 to control playback of media content delivered asynchronously over a communication channel by a remote device (e.g., the first device 110). The playback of the media content is enabled at a predetermined time after the delivery of the media content.

As an alternative to the second device 120, a third device (not shown) may be employed in the system 100. The third device includes a processor that controls playback of media content delivered asynchronously from a remote device. In addition, the third device generates a notification for a user of the device upon receipt of the media content. The notification may be an automatic notification, an audio notification, or an e-mail, for example. As with the second device, the playback of the media content may be enabled at a predetermined time after the delivery of the media content. Similarly, the media content may not be detectable by a user of the third device until the predetermined time.

The processors 140 and 150 of the first device are capable of operating in multiple modes, as described below. The processor 140 of the first device 110 may control the delivery of media content over a communication channel 130 to a remote device (e.g., the second device 120) in one of a first mode and a second mode. In the first mode, the processor 140 controls the asynchronous delivery of media content over the communication channel 130 to facilitate playback of the media content through the remote device. In the second mode the processor 140 controls the synchronous delivery of media content over the communication channel 130 to facilitate the playback of the media content through the remote device.

The processor 140 of the first device 110 may control the delivery of media content over the communication channel 130 to a remote device (e.g., the second device 120) in one of a first mode and a second mode. In the first mode, the processor 140 controls the unicast-based delivery of media content over the communication channel 130 to facilitate playback of the media content through the remote device. In the second mode, the processor 140 controls the multicastbased delivery of media content over the communication channel 130 to facilitate the playback of the media content through the remote device.

A synchronous mode of delivery refers to the delivery of media content in a manner in which the media content is being played back (i.e., watched or listened) at nearly the same time it is being delivered. With respect to a communication channel 130, such as a digital network or the Internet, digital data is stored momentarily in memory buffers before being played back. This mode of delivery is typically referred to as media streaming and the contents of the memory buffers do not survive the playback session. In contrast, an asynchronous delivery mode refers to the delivery of robust media content files which survive the playback session. In this regard, the media content files are delivered “asynchronously”—i.e., without respect to time. Both the unicast and multicast-based mode of delivery are synchronous delivery nodes.

A unicast mode of delivery refers to point-to-point interactive communication over the communication channel 130. (e.g., the Internet). The first device 110 (e.g., a server computer) and the second device 120 (e.g., a client computer) are holding a private and interactive session with each other. In this manner, the second device 120 can request a specific media content item, and the first device 110 delivers that media content item solely to the second device 120. In a multicast mode of delivery, the first device 110 broadcasts the media content items to all devices (including the second device 120) in the communication channel 130. The only way that the first device 110 can control which devices can utilize those media content items is to utilize a digital rights management scheme. By way of example, the media content items may be encrypted and encryption keys distributed to specific devices. The encryption keys are specifically matched to a unique receiver ID. This is the basis for conventional conditional access systems that are used to control cable and satellite TV access in a manner well known in the art.

The processor 150 of the second device 120 may control the playback of media content delivered over the communication channel 130 by a remote device (e.g., the first device 110). The processor controls the playback of media content in one of a first mode and a second mode. In the first mode, the processor controls the playback of media content delivered asynchronously by the remote device. In the second mode, the processor controls the playback of media content delivered synchronously by the remote device.

The processor 150 of the second device 120 controls the playback of media content delivered over the communication channel 130 by a remote device (e.g., the first device 110). The processor 150 controls the playback of media content in one of a first mode and a second mode. In the first mode, the processor 150 controls the playback of media content delivered by the remote device via a unicast mode of delivery. In the second mode, the processor 150 controls the playback of media content delivered by the remote device via a multicast mode of delivery.

The processor 140 of the first device 110 may control the asynchronous delivery of media content, as follows. The first device 110 receives a request for a connection from a remote device (e.g., the second device 120). Thereafter, the first device 110 establishes the connection in response to the request of the remote device and provides the remote device with a first indication that a user of the remote device is entitled to the media content. Then, the first device 110 receives from the remote device a second indication that the remote device will accept the media content for delivery unless the remote device already has the media content.

The first indication may include a first list of a first group of media content items including at least a first media content item, which is the media content. The second indication may include a second list of a second group of media content items including at least a second media content item, which is the media content. The second group of media content items includes a number of media content items including at least the second media content item. The second group of media content items is a group of media content items that the remote device will accept for delivery from the device.

The processor 140 of the second device 120 may control the playback of media content delivered asynchronously over the communication channel 130 by a remote device (e.g., the first device 110) as follows. The second device 120 makes a request for a connection to the remote device. Thereafter, the second device 120 receives a connection from the remote device in response to the request. The second device 120 receives a first indication from the remote device that a user of the second device 120 is entitled to the media content from the remote device. Then, the second device 120 provides a second indication to the remote device that the second device 120 will accept the media content for delivery unless the second device 120 already has the media content.

The first indication may include a first list of a first group of media content items including at least a first media content item, which is the media content. The second indication may include a second list of a second group of media content items including at least a second media content item, which is the media content. The second group of media content items includes a number of media content items including at least the second media content item. The second group of media content items is a group of media content items that the second device 120 will accept for delivery from the remote device.

Two additional alternatives for the second device 120 will now be described to highlight two additional features of the present invention. In one of the additional alternatives, a fourth device (not numbered) is provided having a processor (not numbered) that controls playback of media content delivered asynchronously over a communication channel by a remote device. The device is capable of providing an indication to another on behalf of a user of the device, the indication being of a location where the media content may be found. By way of example, the indication may be a URL address. In another of the additional alternatives, a fifth device is provided having a processor that controls the playback of media content delivered asynchronously over a communication channel by a remote device. The device is capable of providing a portion of the media content to another on behalf of a user of the device. The portion of the media content may be provided as an attachment to an e-mail.

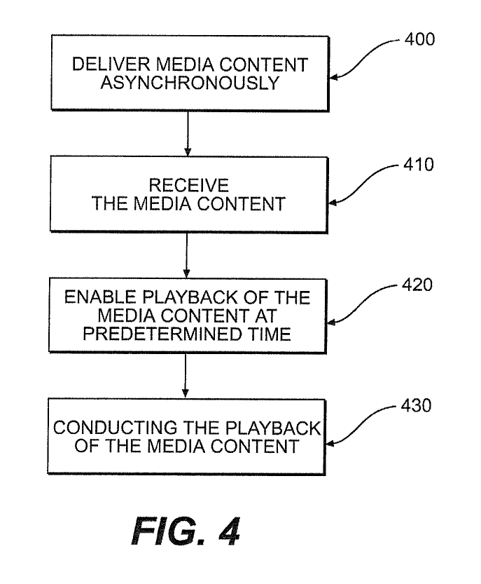

FIG. 4 shows a flow chart featuring the steps of a method of implementing a media content delivery and playback scheme in accordance with the present invention. The method includes the step 400 of delivering media content asynchronously via a communication channel for remote playback of the media content. The remote playback of the media content is enabled at a predetermined time after the delivery of the media content. In addition, the media content may not be detectable until the predetermined time. In step 410, media content is received. Thereafter, in step 420, the playback of the media content is enabled at the predetermined time. The method may also include the step 430 of conducting the playback of the media content after enabling the playback of the media content at the predetermined time. The step of conducting may include the step (not shown) of displaying the media content.

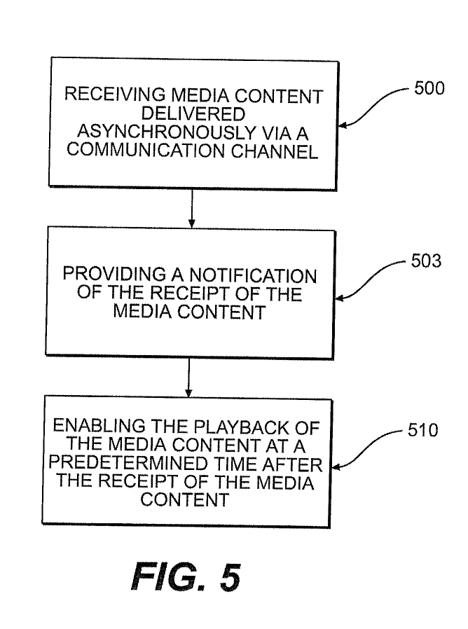

FIG. 5 shows a flow chart featuring the steps of a method of implementing a media content delivery and playback scheme in accordance with the present invention. The method includes the step 500 of receiving media content which is delivered asynchronously via a communication channel, and the step 510 of enabling the playback of the media content at a predetermined time after the receipt of the media content. The method may also include the step 503 of providing a notification of the receipt of the media content. In addition, the method may also include the step (not shown) of detecting the media content at the predetermined time, in which case, the notification Step 503 will not occur until the media content is detected.

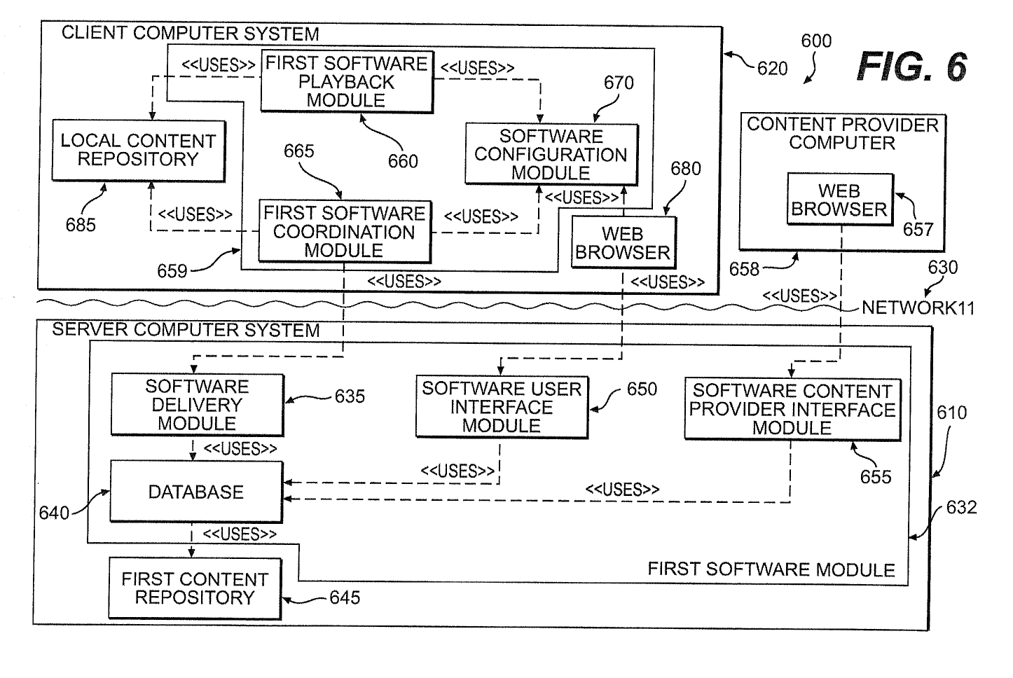

FIG. 6 depicts a system 600 for implementing a media content delivery and playback scheme in accordance with a preferred embodiment of the present invention. The system includes a server computer system 610 including at least a server computer (not shown) having a first processor (not shown). The system also includes a client computer system 620 including at least a client computer (not shown) having a processor (not shown). In addition, the system 600 includes at least a portion of a network 630 by which the server computer system 610 and the client computer system 620 are coupled to each other. The network 630 may be implemented as a local area network, wide area network, a public access network (e.g., the Internet), or a combination of networks.

Both the server and client computers may be implemented as a portable device (e.g., a personal digital assistant), a wireless device, or a portable wireless device (e.g., cellular phone or pager). In addition, although the system 600 is described as a server/client based system, it may also be arranged as a peer-to-peer system, in which each device acts as server with respect to the other device, which, in turn, acts as a client.

The processor of the server computer executes instructions including a first software module 632, which may be stored in a storage device associated with the server computer, or on another device with which the server computer is networked. The storage device may include a hard drive, random access memory, read only memory, a redundant array of inexpensive disks (RAID), an optical disk, a CD-ROM, WORM, floppy disk, or any of a number of storage devices, which are well known to those skilled in the art.

The first software module 632 includes a software delivery module 635 that controls asynchronous delivery of media content over the network 630 to facilitate playback of the media content through the client computer. By storing the media content on the client computer (i.e., a remote device), which is local to the user of the client computer, the system 600 avoids the inconsistent quality that may result from streaming media content over the network 630. By downloading media content in the form of media files automatically, the system 600 eliminates the tedium of hunting for media files and manually downloading them. In addition, the playback of the media content may, in accordance with one aspect of the preferred embodiment, only be enabled at a predetermined time after the delivery of the media content. In addition, the media content may not be detectable by a user of the client computer until the predetermined time.

Preferably, the software delivery module 635 waits to be contacted by the client computer and then interacts with the client computer to coordinate the delivery of media content to the client computer and to coordinate the receipt of user statistical information back from the client computer.

Since the system 600 relies on the download of media content to an often unattended client computer, there may be media content items that are downloaded to the client computer that a user of the client computer will never use. Thus, if the server computer delivered media content items in their entirety, the useable bandwidth for the network 630 may not be allocated efficiently. The first software module 632 may include an adaptive download module (not shown) that monitors the user's actual consumption patterns and determines the media content items that have a higher probability of being consumed or of not being consumed. For those media content items that do not have a high probability of being consumed, the adaptive download module would only download portions of those content items or perhaps cease downloading them altogether. Thus, the total bandwidth load for the network 630 would be reduced.

The server computer may incorporate a database 640 (e.g., a PostgreSQL relational database), or it may have access to the database 640, which may be residing on a storage device within the server computer system 610, or which may be otherwise accessible via the network 630. The database 640 stores information related to the system in the form of metadata. The information must include metadata about the media content available to the system, including for example, descriptions of packages, series and episodes. The information should also include metadata that relates to users of the system. This metadata may include, for example, account information, billing history and statistics. The database need not contain the media files themselves. As an alternative, the media files may be stored within a first content repository 645 associated with the server computer system 610. The contents of the first content repository 645 may be accessible via the database 640.

The first software module 632 may also include a software user interface module 650 and a software content provider interface module 655. These are the public interfaces for users, advertisers and content providers. These interfaces may be operated as graphical user interfaces that are implemented as web sites or web portals. By way of example, users would use the software user interface module 650 to change their subscriptions, view billing histories, or view the available media content (as represented by, for example, episodes, shows, series or pre-defined packages). In addition, the content provider interface module 655 may be accessed by a content provider via a web browser 657 residing on a client computer 658 of the content provider.

The software interface module 650 may also be implemented with a program guide, which would allow users of the client computer to preview media content items. The program guide would allow the user to preview selected media content items by streaming those items (e.g., audio or video content items) to the client computer. A clickable hyperlink in the program guide will launch the user's streaming media player of choice and allow them to read, listen, or see the media content item before subscribing. In addition, content providers may use a software content provider interface module 655, to upload new content and view summary statistics about how their shows were being used by users of the system 600.

The processor of the client computer executes instructions including a second software module which may be stored in a storage device associated with the client computer, or on another device with which the client computer is networked. The storage device may include a hard drive, random access memory, read only memory, a redundant array of inexpensive disks (RAID), an optical disk, a CD-ROM, WORM, floppy disk, or any of a number of well-known storage devices, which are well known to those skilled in the art.

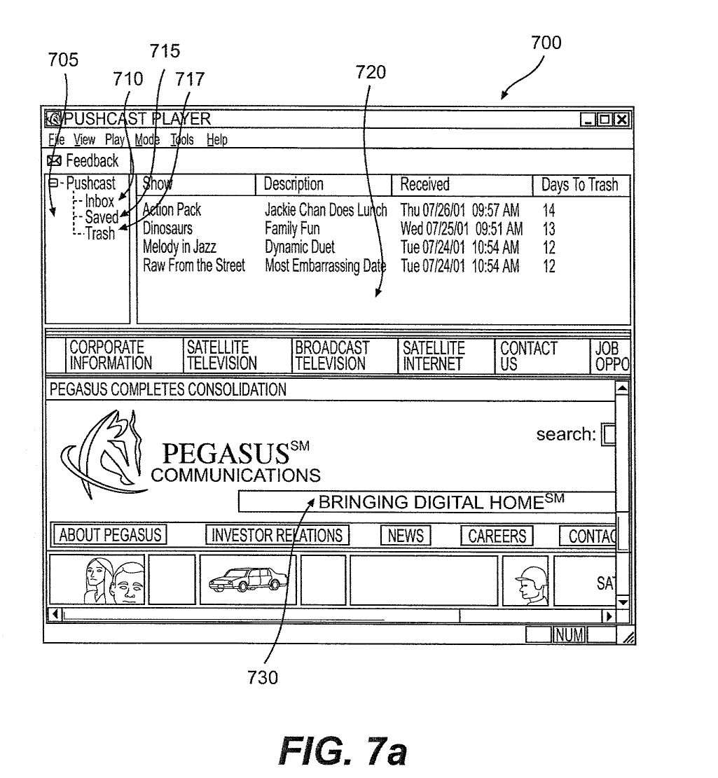

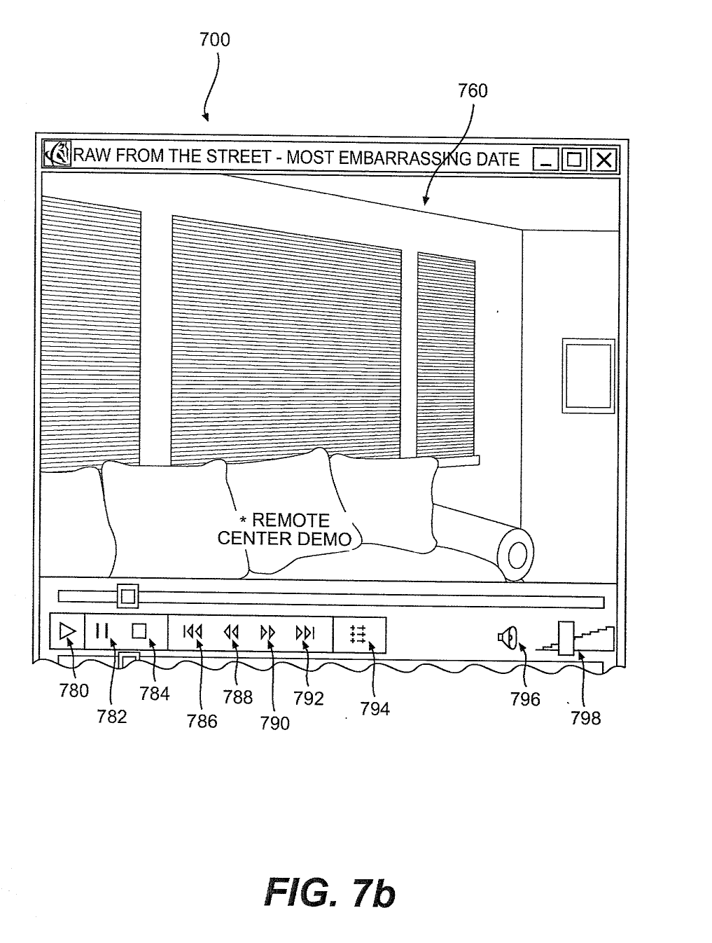

The second software module 659 includes a first software playback module 660 that controls the playback of media content delivered asynchronously over the network 630 by the server computer. The first software playback module 660 includes a graphical user interface 700, as shown in FIG. 7a, that allows the user to view, organize and play back media content. In particular, the graphical user interface 700 of the first software playback module 660 may include various windowpanes. By way of example, there may be a Folders Pane 705 that displays various folders for storing and organizing messages (e.g., an Inbox folder 710, a Saved folder 715 and a Trash folder 717). There may also be a List Pane 720 that lists the media content items contained in a selected folder. By way of example, the List Pane 720 may identify the Show, Episode number, Description, Receive Date and Publish Date of the media content items in the Inbox folder 710. In addition, there may also be a Detail Pane 730 that displays detailed information about a media content item highlighted in the List Pane 720. A user can move media files by dragging those media files and dropping them into specific folders.

The second software module also includes a first software coordination (or synchronization) module 665 that coordinates the exchange of information with the server computer. The first software coordination module 665 contacts the server computer and coordinates the delivery of any new media content files for a user of the client computer. The first software coordination module 665 also uploads user statistics back to the server computer. Using a client computer in accordance with the present invention, a user can have access to a wide variety of media content, including original and re-purposed data, music, videos and multimedia programming.

A variety of types of programming may be supported using the system 600 of the present invention. These types of programming include, for example, stock reports, news items, emergency reports, cartoons, movies, data reports, product reports and detailing, talk shows, music programs, do-it-yourself and repair information, horoscopes, audiobooks, news information, sports information, weather information, political information, dramas, NASCAR shows, personal relationship information and business reporting. The media content may also contain advertisements. In addition to or as an alternative to the use of advertisements, media content may be provided on a fee for content basis.

The second software module 659 also includes a software configuration module 670. A user of the client computer can use the configuration module 670 to configure the software module, as desired.

The second software module also includes a software registration module (not specifically shown) that receives user information from a user of the client computer. The registration module may be implemented as a web browser 680 through which a user of the client computer can interact with the server computer to register or obtain information about media content or the user's account status.

The client computer then transmits the user information to the server computer to facilitate the delivery of media content to the client computer.

The second software module may also access a local content repository 685 to store media content in the form of media files. The local content repository 685 may be a storage device, such as a hard drive, random access memory, a redundant array of inexpensive disks (RAID), an optical disk, a CD-RW, WORM, floppy disk, or any of a number of storage devices that are well known to those skilled in the art.

Initially, a new user will register with the system 600 using the web browser 680. The new user registration process is a one-time event for each user. Using the web browser 680, a new user will access the server computer's software user interface module 650, which is implemented as a web site (or web portal) for end-users. When accessing the server client's web site, the user is prompted to become a system user in accordance with a registration process. In particular, the user fills out an on-screen HTML or XML form (not shown) with various pieces of information including, for example: the user's name, address, e-mail address, credit card information, etc. The server computer uses this information to uniquely identify each of its users to: (a) ensure that the user gets the content they requested; (b) ensure that an administrator of the system gets paid for the services it renders; and (c) provide the system with valuable information for further use (e.g., e-mail addresses for new show notifications).

Once registered, a user would next receive the second software module 659. The user may receive the second software module 659 by downloading it from the server computer's software user interface module 650 to the client computer. A variant on this process would be to distribute the second software module to the user on a storage device, such as a CD-ROM. Thus, instead of downloading the second software module from the server computer's user interface module 650, a user would install the second software module from the storage device. A user would agree to the terms and conditions of use for the second software module and install it on the client computer.

Once the user was registered and had the second software module installed on the client computer, the user would access the server computer's software user interface module 650 via the web browser 680 and identify the media content that the user wishes to receive. This would occur by selecting content from the software user interface module 650. The resulting user selection profile is stored in the database 640.

Encoded in the second software module is the address (e.g., IP address) for the server computer. The client computer uses this address to contact the server computer and establish a connection. Once the connection is made, the client sends information that uniquely identifies that user.

The client computer may contact the server computer on a fixed time interval (e.g., every 15 minutes). Further, the server computer can also provide the client computer with an indication of a predetermined time when the client computer can expect the next piece of content to arrive. This later technique is particularly efficient at handling “special bulletins” and other content that is made available outside of a regular schedule of programming, for example.

Once the client computer identifies the user to the server computer, the server computer takes that information and queries the database 640 for all content to which that user is subscribed. The server computer then sends this entire list to the client. This is done so that the client computer can display on the graphical user interface 700 of the first software playback module 660 a progress bar, which indicates how many items have been received and how many are yet to come.

The server computer then proceeds to offer every one of these content items to the client computer for download. The client computer checks to see if it already possesses the specific media content in the form of a media file. If the client computer possesses the specific media content item, then the client computer refuses the download offer and the server computer skips to the next item on the list. If the client computer does not have the media content item, then the client computer accepts the download of the media content item from the server computer and stores the media content in the local content repository 685.

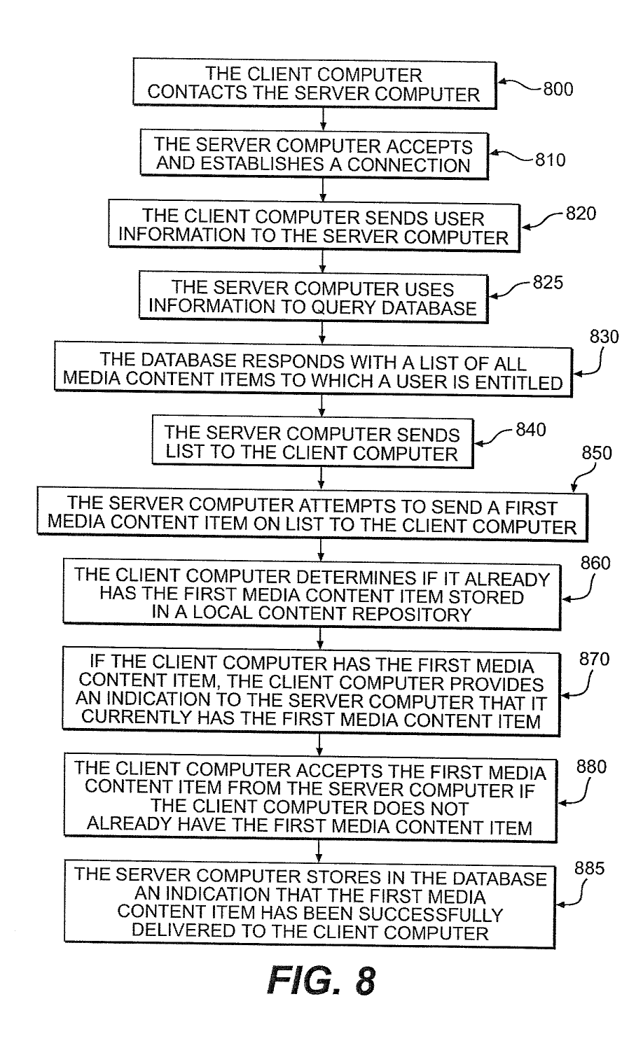

Although generally described above, the client and server computers may interact in accordance with one of two protocols. The first protocol is illustrated in FIG. 8. In step 800, the client computer contacts the server computer and requests a connection. In step 810, the server computer accepts and establishes the connection. Thereafter, in step 820, the client computer sends user information to the server. Thereafter, in step 825, the server computer uses the user information to query the database 640. In step 830, the database responds with a list of all content to which that user is entitled. In step 840, the server computer sends the list to the client. Thereafter, in step 850, the server computer attempts to send a first media content item on the list to the client computer. In step 860, the client computer determines if it already has the media content item stored in the local content repository 685. If the client computer does have the media content item, then in step 870, the client computer provides an indication to the server computer that it currently has the media content item, such that the server computer will offer the next media item on the list. If the client computer does not have the media content item, then in step 880, the client computer accepts the media content item from the server computer. Thereafter, steps 850-880 are repeated for each media content item, as necessary.

After the media content item has been successfully downloaded, in step 880, the step 885 may be performed as an additional option, in which the server computer stores in the database 640 an indication that the media content item has been successfully downloaded to the client computer. Thus, when the server queries the database about which items to offer for future download to the client computer, the database 640 will return only those items which have not already been downloaded to the client computer, rather than a comprehensive list of all media content items to which a user of the client computer may be entitled.

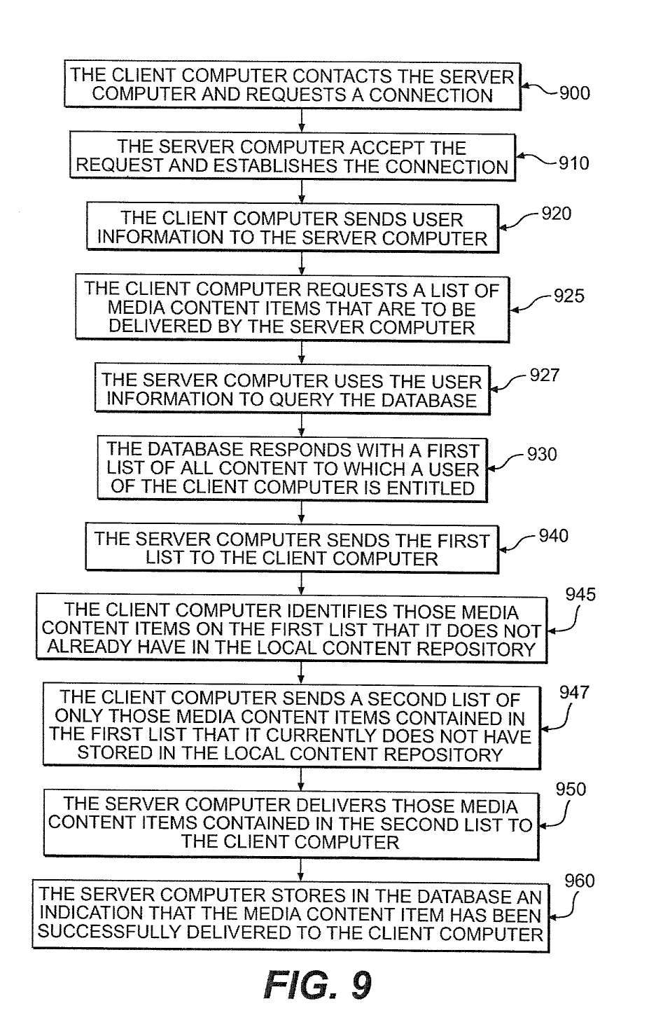

The second protocol is illustrated in FIG. 9. In step 900, the client computer contacts the server computer and requests a connection. In step 910, the server computer accepts and establishes the connection. Thereafter, in step 920, the client computer sends user information to the server. In step 925, the client computer would request a list of content that should be delivered. In step 927, the server computer uses the user information to query the database 640. In step 930, the database 640 responds with a first list of all content to which that user is entitled, which may be implemented as, for example, XML file. In step 940, the server computer sends the first list to the client computer. Thereafter, in step 945, the client computer identifies those media content items on the first list that it does not already have in the local content repository 685. In step 947, the client computer would send a second list of only those media content items contained in the first list that it currently does not have stored in the local content repository 685. In step 950, the server computer delivers those media content items contained in the second list to the client computer.

After the media content items have been successfully delivered, in step 950, the step 960 may be performed as an additional option, in which the server computer stores in the database 640 an indication that the media content item has been successfully downloaded to the client computer. Thus, when the server queries the database about which items to offer for future download to the client computer, the database 640 will return only those items which have not already been downloaded to the client computer, rather than a comprehensive list of all media content items to which a user of the client computer may be entitled.

Once a media content item has been successfully downloaded to the client computer's local content repository 685, the new media content item will appear in the graphical user interface 700 of the first software playback module 660. In particular, the media content item will appear in the Inbox folder 710 of the graphical user interface 700 along with other media content items that have already been downloaded from the server computer.

Typically, a user would start by checking their Inbox folder 710 for new media content. The graphical user interface 700 of the first software playback module 660 displays new, unused content items in the List Pane 720 in highlighted text, and read/listened/viewed items in normal un-highlighted text. If a user clicked a single time on a particular media content item appearing in the List Pane 720 using a mouse associated with the client computer, details about the selected media item would appear in the Detail Pane 730. To delete a media content item, a user would either drag the item using a mouse to the Trash folder 717, or select the content item and press the DELETE key on a keyboard associated with the client computer. In addition, users of the client computer can manage media content items by creating folders in the Folders Pane 705 and then dragging and dropping media content items into those folders.

To playback a media content item (e.g., read, listen, or view a media content item), a user would double click on it in the List Pane 720 using a mouse. This action would initiate a separate media playback window appearing in the graphical user interface 700 with discrete control functions (e.g., “PLAY,” “STOP,” “PAUSE,” “FORWARD,”0 “REVERSE,” and “RECORD” control functions). In addition, as noted above, the discrete control functions may be activated with a remote control device, in a manner well known in the art. By way of example, a remote control device employing an infrared wave may be used.

Every time a user clicks one of the discrete control functions using a mouse or activates one of those functions using a remote control device, that action is recorded to a statistics log file stored on a storage device (e.g., hard drive) associated with the client computer. By way of example, the log file may record a user/player ID, a content ID, the absolute time (AM/PM), and the offset from the beginning of the content file to the action (e.g., STOP or PLAY). At the end of every session between the client and server computers, the server computer queries the client computer as to whether a log file is present. If there is a log file present, it is uploaded to the server computer, where it is parsed and placed in the database 640 for future analysis. When the log file has been successfully uploaded, it is deleted off of the storage device associated with the client computer.

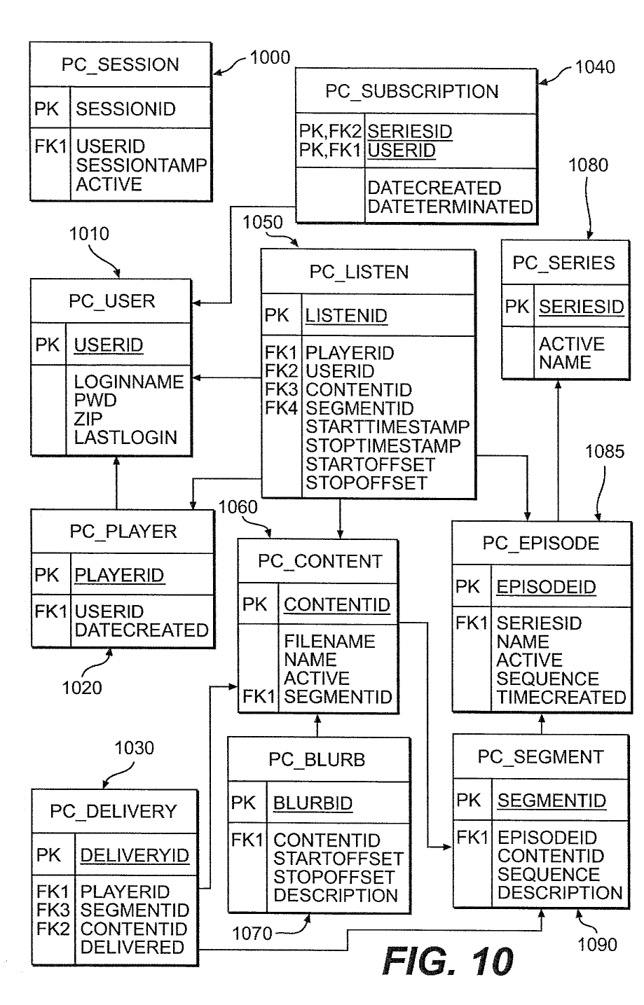

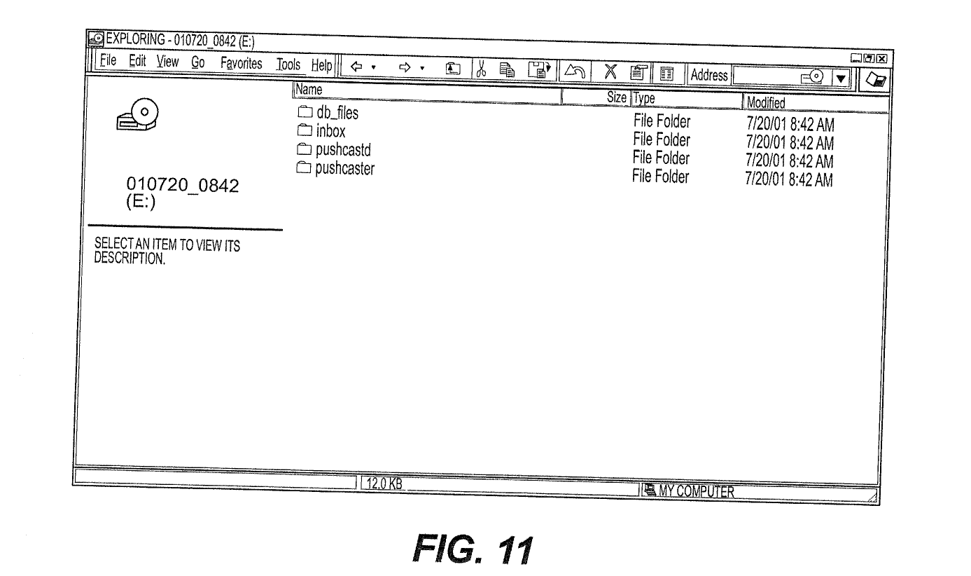

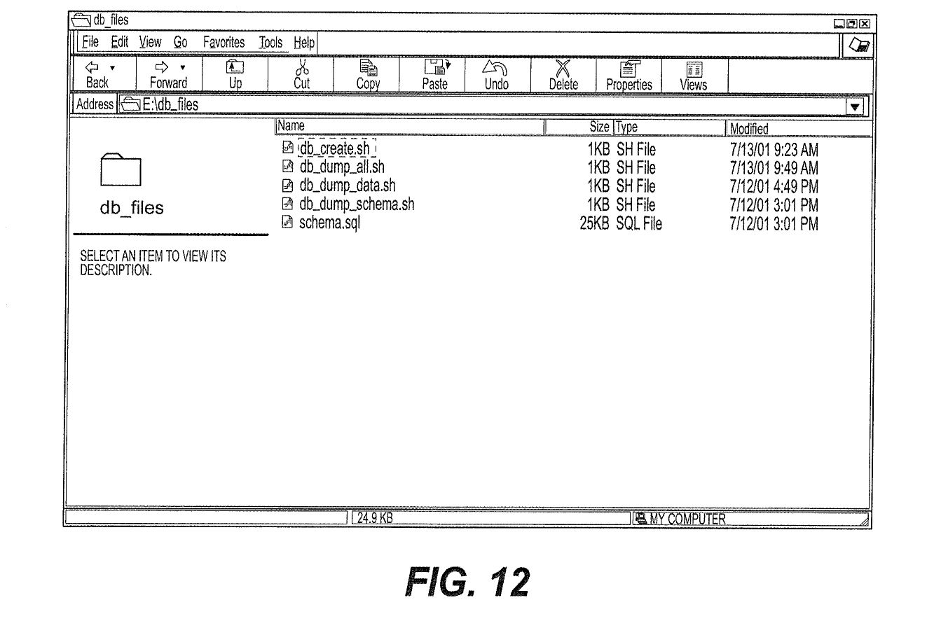

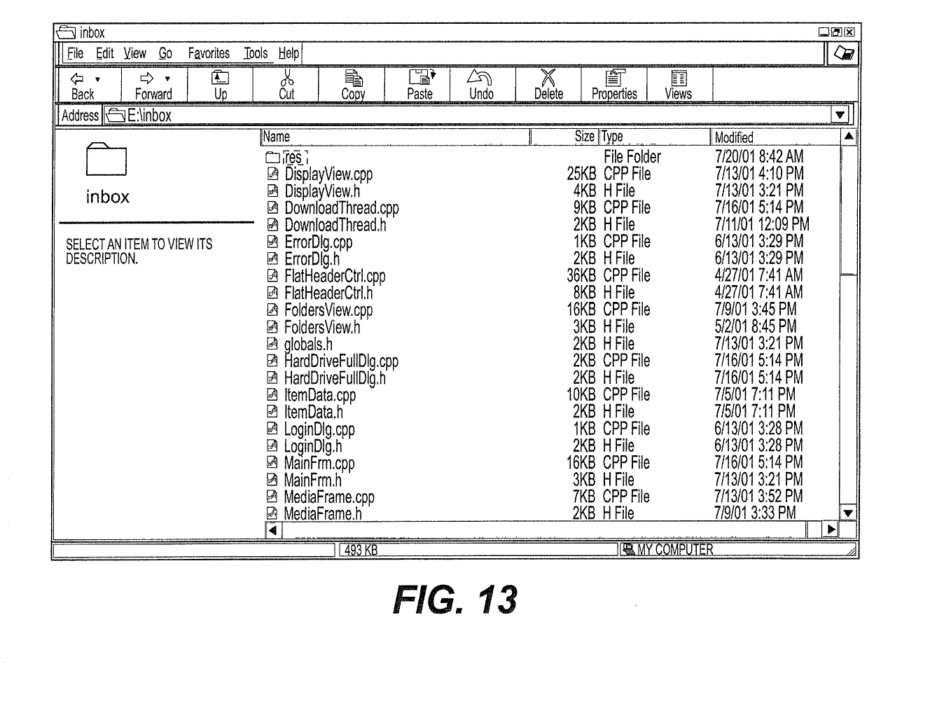

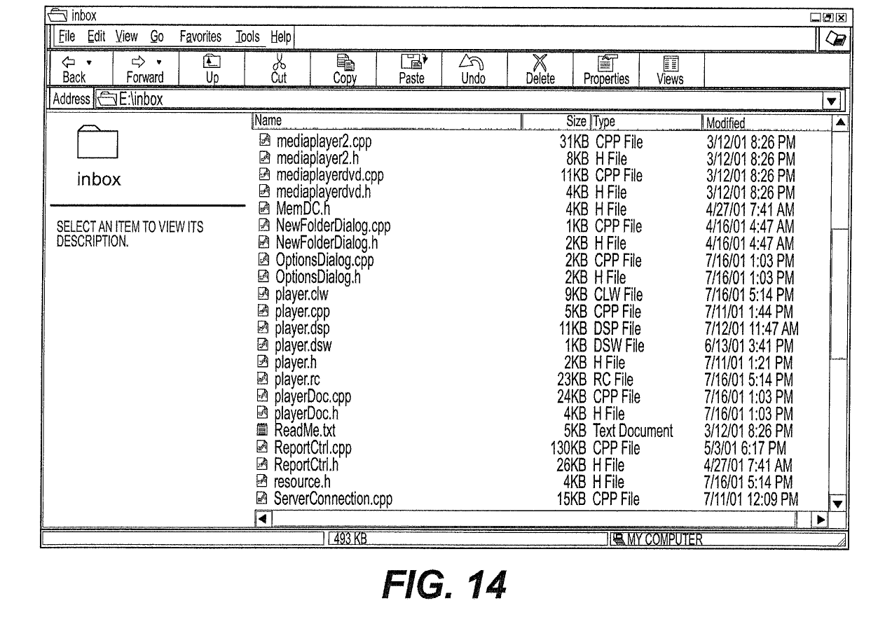

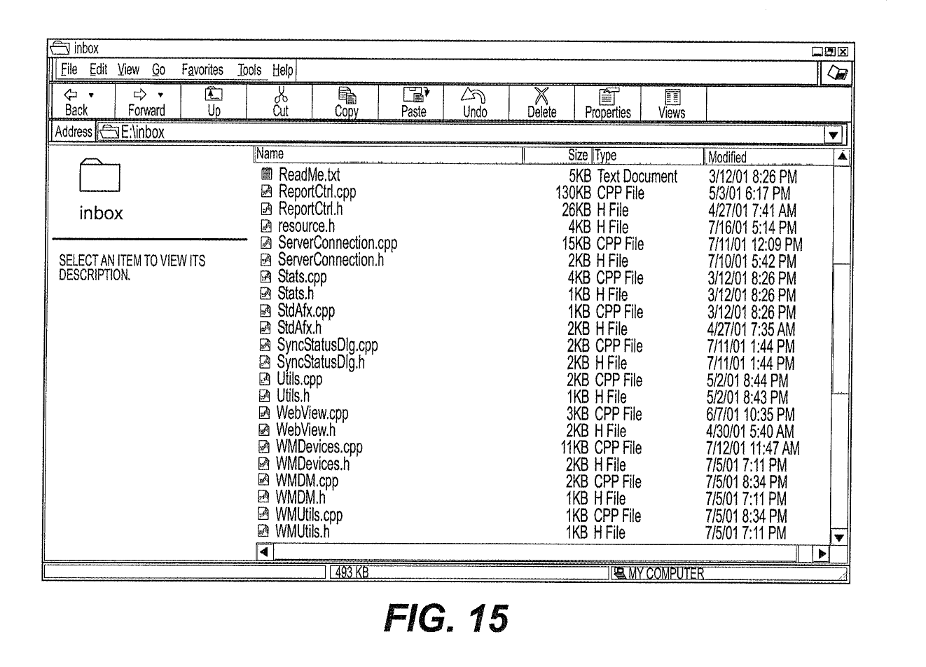

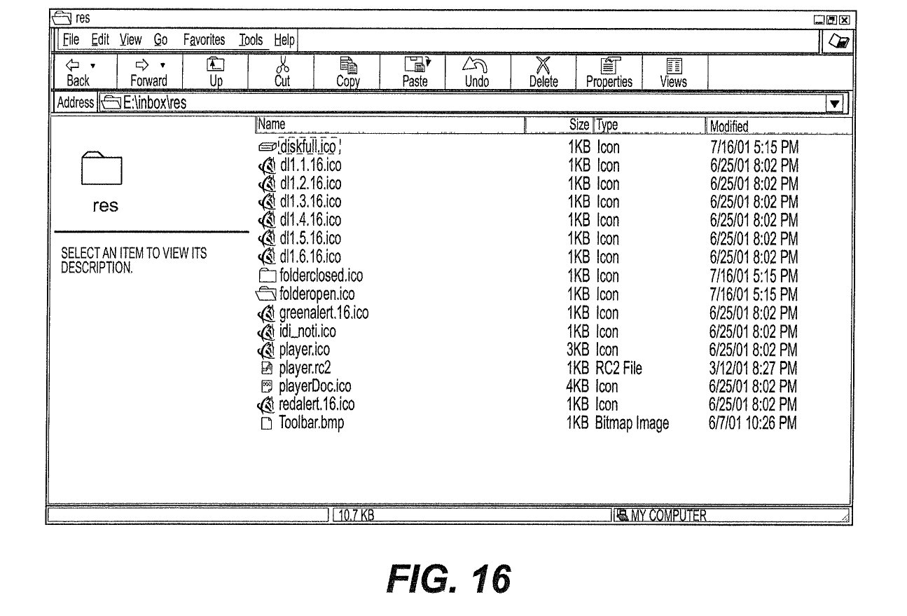

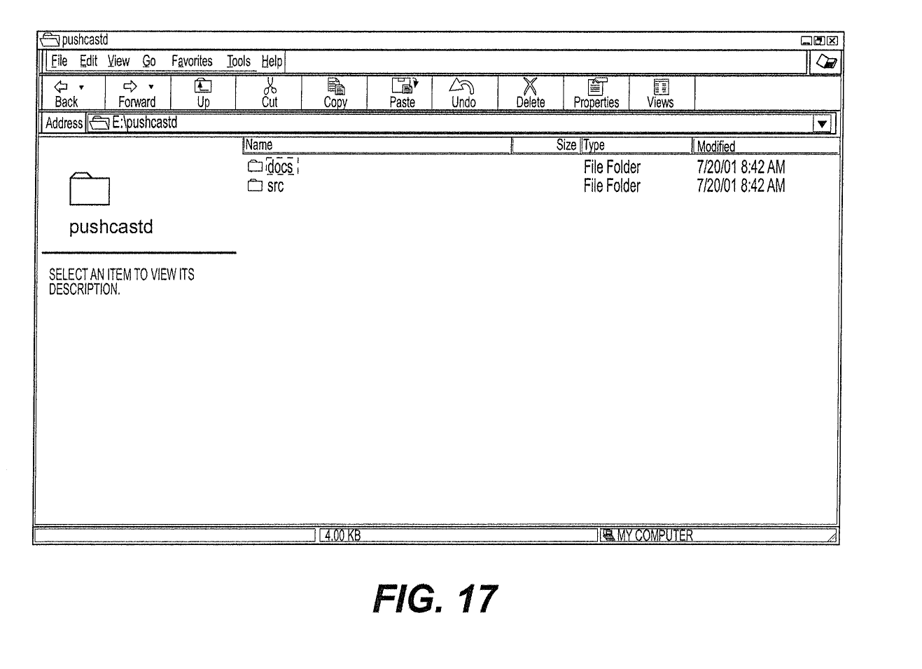

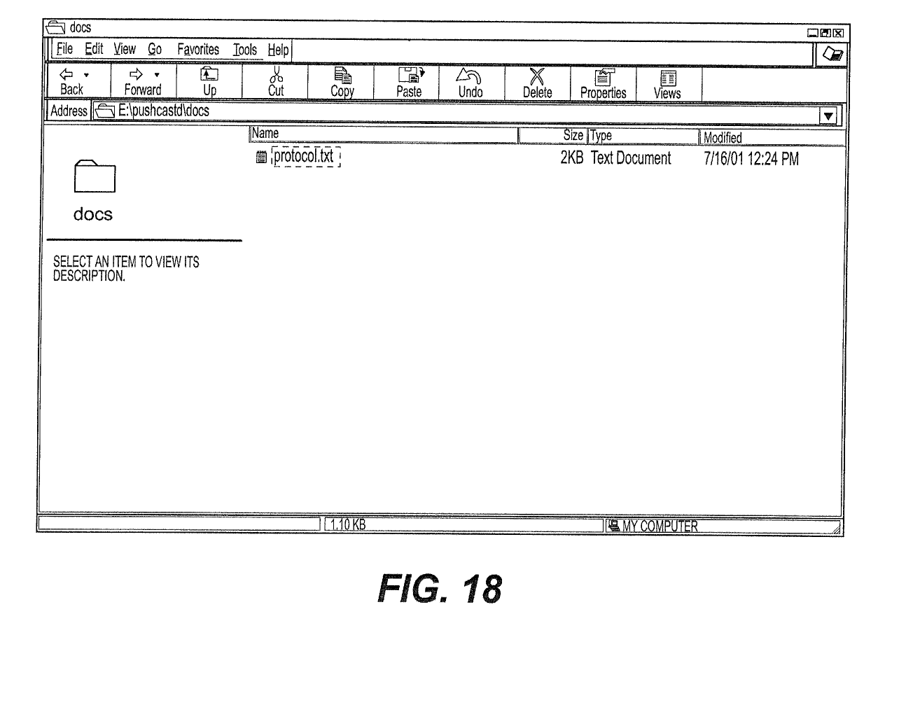

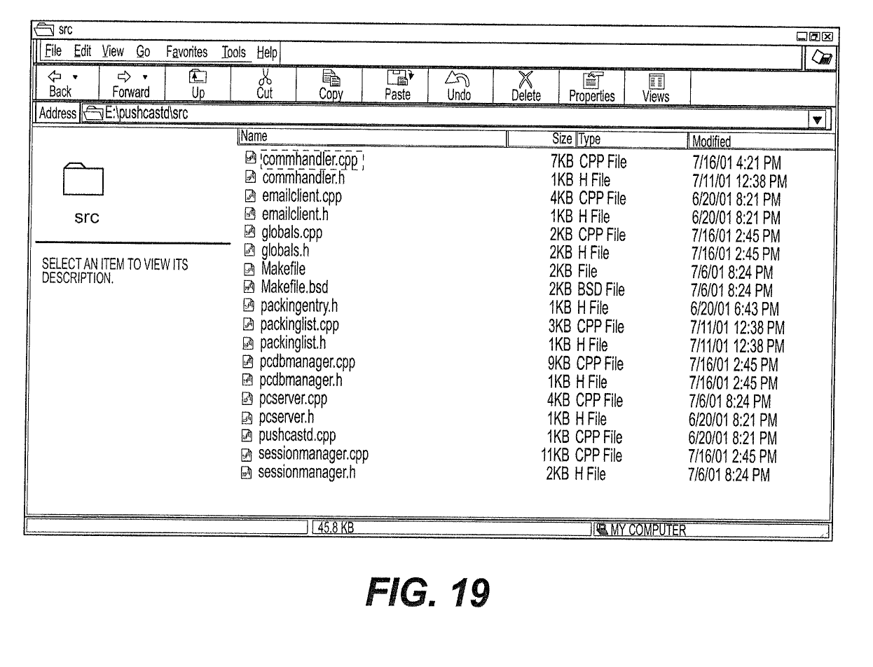

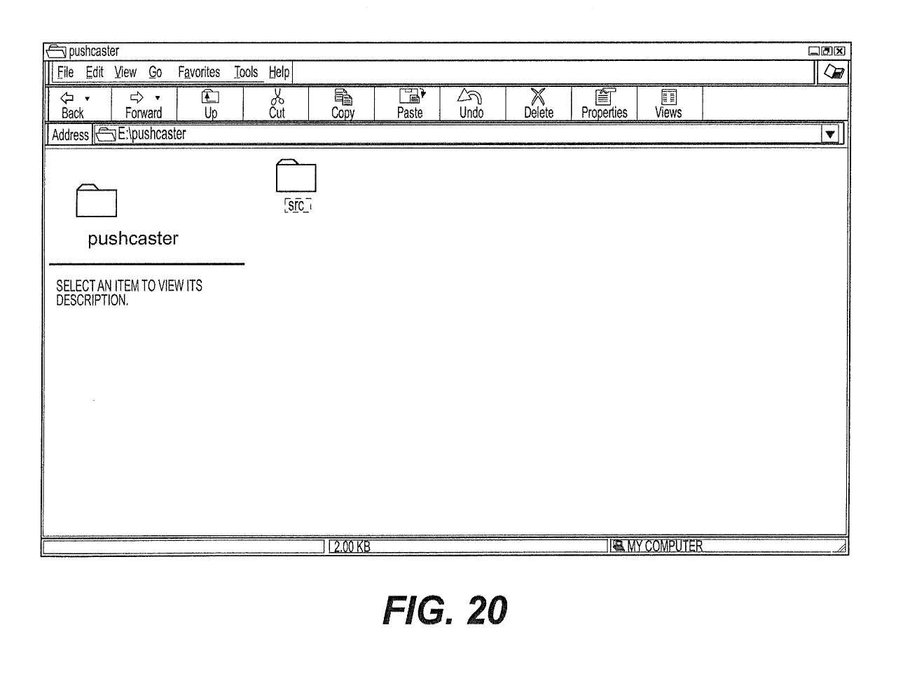

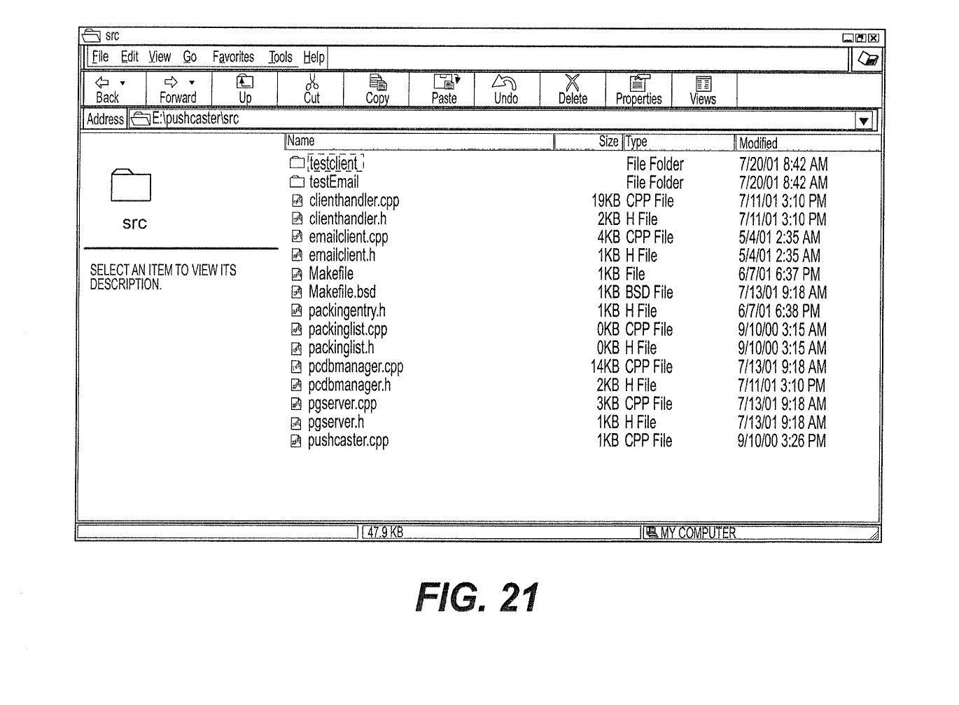

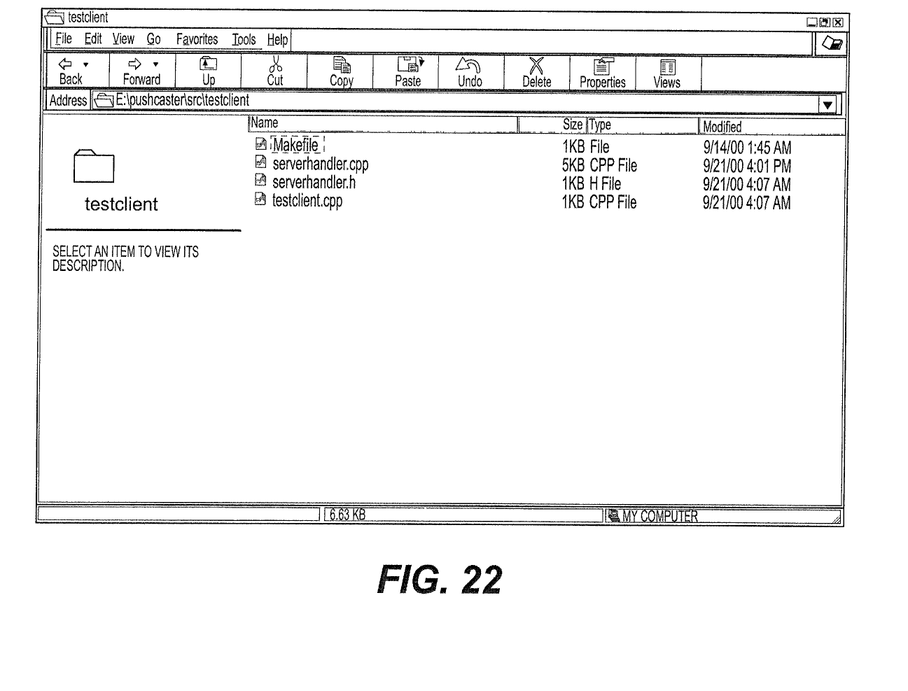

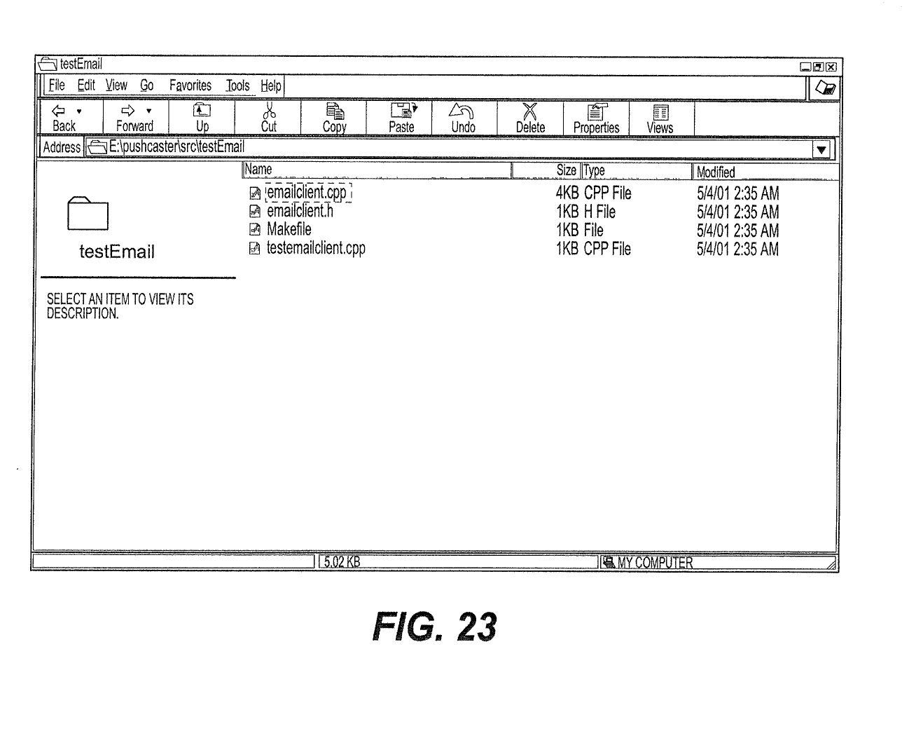

FIG. 10 depicts classes of objects stored in the database 640 along with their attributes. These classes include a pc_session class 1000, a pc_user class 1010, a pc_player class 1020, pc_delivery class 1030, a pc_subscription class 1040, a pc_lisent class 1050, a pc_content class 1060, a pc_blurb class 1070, a pc_series class 1080, a pc_episode class 1085, and a pc_segment class 1090.

The pc_session class 1000 includes the following attributes: sessionid, userid, sessionstamp and active (a status indicator). The pc_user class 1010 includes the following attributes: userid, loginname, pwd (password), zip and lastlogin. The pc_player class 1020 includes the following attributes: playerid, userid, datecreated. The pc_delivery class 1030 includes the following attributes: deliveryid, playerid, segmentid, contentid, delivered (a status indicator). The pc_subscription class 1040 includes the following attributes: seriesid, userid, datecreated, and dateterminated. The pc_lisent class 1050 includes the following attributes: listenid, playerid, userid, contentid, segmentid, starttimestamp, stoptimestamp, startoffset, and stopoffset. The pc_content class 1060 includes the following attributes: contentid, filename, name, active (a status indicator), and segmentid. The pc_blurb class 1070 includes the following attributes: blurbid, contentid, startoffset, stopoffset, and description. The pc_series class 1080 includes the following attributes: active (a status indicator) and name. The pc_episode class 1085 includes the following attributes: episodeid, seriesid, name, active (a status indicator), sequence, and timecreated. The pc_segment class 1090 includes the following attributes: segmentid, episodeid, contentid, sequence, and description.

In addition to those features already mentioned there are additional features that may be associated with the second software module, as set forth below. By way of example, the second software module would provide a user of the client computer with the capability to place a media content marker (or bookmark) within the content item to mark a place to which they want to return. This content marker feature could be implemented using additional control functions on the graphical user interface 700. The functions would enable a user to create, rename, delete and forward such media content markers.

An example of another feature of the second software module is that it may generate a notification to a user of the client computer upon receipt of a media content item. The notification may be an automatic notification, an audio notification, or an e-mail, for example, which is sent to the user's e-mail address.

An example of another feature of the second software module is a locator indication feature, which would allow users of the client computer to send to anyone via the network an indication (e.g., an e-mail) of a location (i.e., link to a URL address) where the media content item may be found. At such a location, a recipient of the indicator may find not just media content items, but previews of the media content item featured using a media streaming technique.

An example of yet another feature of the second software module is a media content sharing feature, which would allow a user to send a portion or segment of a media content item to another individual. By way of example, a user could snip out a small segment of the content and attach that media content portion or segment directly to an e-mail for distribution to another individual. That individual would then be able to play this directly from the e-mail.

The distribution of media content via the media content sharing feature would be controlled using a digital rights management scheme as described below. The digital rights management scheme would take into account a content provider's rules on, for example, whether a user will be allowed to make a media content segment, how long the segment would be, what the encoding rate would be. Because there is great variability in the type of rules applicable to each media content item or portion thereof, every piece of content could conceivably have different rules attached to it. Thus, the media content sharing feature should be implemented in accordance with the digital rights management scheme.

It is preferable that the system 600 be implemented in accordance with a digital rights management scheme to guard against the unauthorized exploitation of media content. Absent such a scheme, content providers would be reluctant to entrust the system 600 with their content. Nor would it be prudent for the administrator of the system to entrust that content to end-users. Therefore, the system 600 should provide safeguards media content cannot be easily duplicated or distributed in an unauthorized manner, and ensure that the administrator of the system receives compensation for the use of media content items by end users. Such safeguards would require encrypting the media content items in such a manner that only the users who have paid for the use of the media content items may use them.

A class of software applications known as digital rights management systems has been developed to meet the protection requirements of the content producers. Digital rights management ensures that only authorized users can use a media content item. Furthermore, digital rights management allows for the application of very sophisticated rules for the use of this content. By way of example, a user may be able to playback a media content item a certain number of times for no fee. Thereafter, the user can playback the media content item additional times for a particular sum of money. Alternatively, a user may purchase the media content item outright for another particular sum. Thus, there is a close relationship between digital rights management, e-commerce and billing. Examples of digital rights management schemes are featured in U.S. Pat. Nos. 6,185,683 and 6,253,193, which are all incorporated herein by reference and assigned to Intertrust Technologies Corp. Intertrust Technologies Corp. has developed digital rights management software, the MetaTrust Utility®, which may be implemented as a digital rights management scheme in the system 600 and the components used in the system 600. In addition, Microsoft has published a reference, “Digital Rights Management for Microsoft Windows Media Technologies”, in 2001. Microsoft's Windows Media Rights Manager® may also be implemented as a digital rights management scheme in the system 600 and the components used in the system 600. Additional examples of digital rights management schemes are featured in U.S. Pat. Nos. 5,530,235; 5,629,980; 5,634,012; 5,638,443; 6,233,684; and 6,236,971; which are all incorporated herein by reference.

The general trend of the consumer electronics industry is to put data, audio and video capabilities on smaller and smaller portable devices, such as personal media players. Therefore, the second software module has the capability to transfer media files to/from portable devices in accordance with a digital rights management scheme. The second software module may incorporate well-known libraries for personal media player support. Another way to transfer media content items using the second software module would be to permit users to create CD-ROMs containing media content items in accordance with a digital rights management scheme.

A full variety of content purchase transactions may be accommodated using the system 600. These transactions include monthly fees for bundles of series (“packages”); purchases of individual series (“a la carte”); purchases of individual episodes (“pay per view” or “PPV”). In addition to managing the how much content the end user receives, digital rights management also manages how long such media content items remain available. For example, a user may have access to a particular media content item in perpetuity, or just provide access to a particular media content item for a predetermined period of time (e.g., a single day).

The system 600 may implement various advertising schemes. By way of example, data, audio and video ads may be placed directly in the media itself, much in the same way that television ads are placed between shows. This form of media advertising is referred to as an “In-Media Ad”. In addition, traditional HTML ads (e.g., banners, b-boxes) may be associated with media content items and displayed in an additional window pane of the graphical user interface 700. These HTML ads could have hotspots which, when clicked using a mouse, would take the user to a special promotional page or a third-party vendor's website. These are called “Third-Pane Ads”. Or a full multimedia advertisement could be delivered as an in-box item, just like a new episode. This form of media advertising is referred to as an “Inbox Ad”.

The system 600 may implement a traffic monitoring system that can accurately manage this diverse advertising environment. Aggregate behavioral statistics collected from users may be used to precisely target ads based on a host of parameters such as content item; geographic area; user age; user gender; and user income. Thus users may be exposed to different advertising based on their behavioral statistics. By way of example, if a user regularly watches a program called “Bass Fishing Today”, that user may be interested in purchasing some gear for a future fishing trip. There are several ways to take advantage of this commercial opportunity. By way of example, a simple affiliation relationship may exist where a button is provided in an additional windowpane of the graphical user interface 700. By clicking on the button using a mouse, a user may be transferred to a third-party vendor's web site. Alternatively, system 700 may maintain inventory and manages its own e-commerce product clearinghouse.

Preferably, a user will never have to re-type user information to make a purchase from the system. Thus, user data could be exchanged with third-party vendors to automatically set up an account for the user. Alternatively, the purchased merchandise may be billed to the user's system account.

In addition, each monthly subscription bill sent to a user could be used to enable micro-payments. Credit card companies charge two fees for every purchase: a fixed per-transaction fee and then a percentage of the transaction amount. The fixed fee means that purchases under, for example, ten dollars are pretty expensive. Accordingly, aggregate purchases could be placed on the user's monthly subscription bill and then a fee would only have to be paid to a credit card company based on the larger amount.

If a user has chosen to subscribe to a specific media content item or type of media content item, there may be other subscribers who enjoy the same media content items. The system 600 may provide vehicles for interaction amongst users subscribing to similar media content items. Three conventional techniques for providing such a vehicle include threaded messaging, instant messaging and chat rooms. Threaded messaging, also referred to as bulletin boards, is a virtual location where users converse asynchronously via e-mail type messages. Typically, a user starts a topic, or “thread” and people respond to that message, or respond to the responses thereof. Threaded messaging is useful because the messages accumulate, allowing you to read the entire discussion on a particular topic. Instant messaging is text-based user-to-user communication, which occurs in real-time and does not leave behind a body of messages like threaded messaging. Instant messaging is an extremely popular way for users to communicate over the network (e.g., Internet). Chat rooms are like instant messaging, but it permits group discussions to occur as messages are sent to all users in the chat room. The system 600 could also allow users to rate and/or recommend content items to others.

The operation of system 600 will now be discussed. A user opens the graphical user interface 700 of the first software playback module 660 on a display of the client computer. The user clicks on the Inbox folder 710 using the mouse associated with the client computer and finds at least five new media content item have been delivered. The adaptive download module on the server computer system has determined that while the user initially registered for a first media content item (or type of media content item), the user does not actually playback the first media content item often. Thus, only a segment of the first media content item has been downloaded.

The user also subscribes to a particular programming series and one of the episodes in that series is included as a second media content item in the Inbox folder 710. During the playback of the second media content item, there is a review of five different products, as well as five links to the vendors of those products that are displayed in a window pane of the graphical user interface 700. After hearing the review, the user clicks on one of the links using a mouse and goes to that vendor's website to make a purchase.

A third media content item is included in the Inbox folder 710 and the user decides to watch the show by clicking on that media content item. The third media content item is an episode of a series featuring a comedian doing a stand-up routine. Using the media content sharing feature, the user makes a segment of the media content item, which features the best joke of all and sends it to another user via e-mail. She also places a media content marker at that point so that the user can return to it later. The user may also go to a bulletin board for the third media content item and post the user's thoughts about the comedian. The user may also receive an instant message from another user regarding the third media content item.

A fourth media content item containing a news audio program is included in the Inbox folder 710. The user decides to listen to the latest installment of the news audio program to which the user subscribes. The sponsor for this content item knows from the statistical user information gathered for that user, that the user is a woman between 35-50 years of age and making between $25,000 to $35,000 a year income. The dynamic advertisement insertion feature inserts the advertisement that will most likely appeal to Jane. In accordance with a digital rights management scheme, the user also has a CD-ROM burned containing the fourth media content item using a CD drive associated with the client computer. Thus, the fourth media content item is available playback.

A fifth media content item is also included in the Inbox folder 710. It's a pay per view program, which features an interview with an entertainment personality and only costs a small fee. Although the small fee would be added to Jane's regular monthly bill if the user consumes or plays back the fifth media content item, the user is doubtful about the value of the program. Accordingly, the user accesses the server computer's website and checks out the comments and user ratings section of the website to see what other users have thought about the fifth media content item. In addition, the user previews a portion of the fifth media content.

What is claimed is:

1. A device comprising a processor that controls asynchronous delivery of media content over a communication channel to facilitate playback of the media content through a remote device, wherein the playback of the media content is enabled at a predetermined time after the delivery of the media content.

2. The device defined in claim 1, wherein said device delivers the media content.

3. The device defined in claim 1, wherein said communication channel includes a satellite communication channel.

4. The device defined in claim 2, wherein said device is a server computer.

5. The device defined in claim 1, wherein said device is a server computer.

6. The device defined in claim 1, wherein the delivery of the media content is controlled in accordance with a digital rights management scheme.

7. The device defined in claim 1, wherein said remote device includes a client computer.

8. The device defined in claim 1, wherein said remote device is a portable device.

9. The device defined in claim 8, wherein said portable device is a wireless device.

10. The device defined in claim 9, wherein said wireless device is a cellular phone.

11. A device comprising a processor that controls asynchronous delivery of media content over a communication channel including a satellite system to facilitate playback of the media content through a remote device, wherein the playback of the media content is enabled at a predetermined time after the delivery of the media content.

12. A device comprising a processor executing software instructions including a software module comprising:
a software delivery module that controls asynchronous delivery of media content over a communication channel to facilitate playback of the media content through a remote device, wherein the playback of the media content is enabled at a first predetermined time after the delivery of the media content.

13. The device defined in claim 12, wherein said device delivers said media content.

14. The device defined in claim 13, wherein said device is a server computer.

15. The device defined in claim 14, wherein said device further comprises a memory portion that stores at least a portion of said software module.

16. The device defined in claim 12, wherein said device further comprises a memory portion that stores at least a portion of said software module.

17. The device defined in claim 12, wherein the software delivery module generates indicator data for the remote device that provide an indication of a second predetermined time when the media content will be delivered to the remote device, said device transmitting the indicator data to the remote device at the second predetermined time.

18. The device defined in claim 17, wherein the remote device initiates a session with the software delivery module at the second predetermined time.

19. The device defined in claim 18, wherein the remote device initiates the session by making a request for a connection with said device.

20. The device defined in claim 19, wherein said device establishes the connection in response to the request.

21. The device defined in claim 20, wherein said device provides the remote device with an indication that a user of the remote device is entitled to the media content.

22. The device defined in claim 21, wherein remote device accepts the media content for delivery unless the remote device already has the media content.

23. The device defined in claim 12, wherein the software module further comprises a software recovery module, which provides control information to the software delivery module to enable the automatic delivery of disrupted data without delivering data that has already been successfully delivered to the remote device.

24. The device defined in claim 12, wherein the software module further comprises a software database interface module that processes requests to retrieve information from a database including media content information related to the media content.

25. The device defined in claim 24, wherein the software database interface module receives a request for the information from the remote device, submits the request to the database, receives the information from the database, and sends the information to the remote device.

26. The device defined in claim 24, wherein the software database interface module receives a request for the information from the software delivery module, submits the request to the database, receives the information, and sends the information to the software delivery module to facilitate the delivery of the media content to the remote device.

27. The device defined in claim 24, wherein the media content information includes at least an identifier identifying a media category with which the media content is associated.

28. The device defined in claim 27, wherein the media category is a segment of an episode with which the media content is associated.

29. The device defined in claim 27, wherein the media category is an episode with which the media content is associated.

30. The device defined in claim 27, wherein the media category is a series with which the media content is associated.

31. The device defined in claim 27, wherein the media category is a package with which the media content is associated.

32. The device defined in claim 31, wherein the package is defined in accordance with user statistical information related to media usage by a user employing the remote device.

33. The device defined in claim 12, wherein said software delivery module controls the delivery of the media content based on user statistical information concerning media usage by a user employing the remote device.

34. The device defined in claim 33, wherein the software delivery module controls the delivery of the media content in segments, each having a size which depends on the user statistical information.

35. The device defined in claim 25, wherein the software module further comprises a software user interface module that processes requests for the information from a user of the remote device and submits the requests for the information to the software database interface module for retrieval from the database.

36. The device defined in claim 35, wherein the software user interface module further comprises a graphical user interface.

37. The device defined in claim 36, wherein said graphical user interface is implemented via a web site.

38. The device defined in claim 24, wherein the software module further comprises a software storage module that facilitates the storage of media content in a media content repository by a content provider.

39. The device defined in claim 38, wherein the software database interface module receives a request for the information from the software storage module, submits the request to the database, receives the information from the database, and sends the information to the software storage module to facilitate storage of the media content in the media content repository.

40. The device defined in claim 38, wherein the software module further comprises a software content provider interface module that processes requests for the information from a content provider and submits the requests for the information to the software database interface module for retrieval from the database.

41. The device defined in claim 40, wherein said software content provider interface module further comprises a graphical user interface.

42. The device defined in claim 41, wherein said graphical user interface is implemented via a web site.

43. A device comprising a processor that controls playback of media content delivered asynchronously over a communication channel by a remote device, wherein the playback of the media content is enabled at a predetermined time after the delivery of the media content.

44. The device defined in claim 43, wherein said media content is not detectable by a user of the device until the predetermined time.

45. The device defined in claim 43, wherein said processor controls the playback of media content via a display.

46. The device defined in claim 43, further comprising a display, wherein said processor controls the playback of media content via said display.

47. The device defined in claim 43, wherein said device is a computer.

48. The device defined in claim 43, wherein said device is a client computer.

49. The device defined in claim 47, wherein said communication channel includes a network and said computer is coupled to said remote device via the network.

50. The device defined in claim 43, wherein said device is a portable device.

51. The device defined in claim 50, wherein said device is a wireless device.

52. The device defined in claim 51, wherein said wireless device is a cellular phone.

53. The device defined in claim 51, wherein said wireless device includes a display and said processor controls the playback of media content via said display.

54. A device comprising a processor executing software instructions including a software module comprising:
a first software playback module that controls the playback of media content delivered asynchronously over a communication channel by a remote device, wherein the playback of the media content is enabled at a predetermined time after the delivery of the media content.

55. The device defined in claim 54, wherein the media content is not detectable by a user of the device until the predetermined time.

56. The device defined in claim 54, wherein the delivery of media content is controlled in accordance with a digital rights management scheme.

57. The device defined in claim 54, wherein said communication channel includes a satellite communication channel.

58. The device defined in claim 54, wherein said first software playback module controls the playback of media content via a display.

59. The device defined in claim 54, further comprising a display, wherein said first software playback module controls the playback of media content via said display.

60. The device defined in claim 59, wherein said first software playback module comprises a graphical user interface through which the media content is displayed on said display.

61. The device defined in claim 60, wherein the media content is not detectable by a user of the device until the predetermined time.

62. The device defined in claim 54, wherein said software module further comprises a first software coordination module that coordinates the exchange of information with said remote device, the information including the media content.

63. The device defined in claim 62, wherein the information further includes user statistical information related to media usage by a user employing the device.

64. The device defined in claim 63, wherein the user statistical information is sent by the device to the remote device to facilitate the delivery of the media content to the device.

65. The device defined in claim 54, further comprising a storage area that stores media data including the media content.

66. The device defined in claim 65, wherein the media data includes a plurality of media files, the media content being formed from the plurality of media files in accordance with at least one predefined rule.

67. The device defined in claim 66, wherein at least one of the plurality of media files may be used to form a distinct media content.

68. The device defined in claim 54, wherein said software module further comprises a first registration module that receives user information from a user of the device, said device transmitting the user information to said remote device to facilitate the delivery of the media content to the device.

69. The device defined in claim 54, wherein the playback of media content is controlled based on user input.

70. The device defined in claim 69, wherein the user input is provided to said device using a remote control device which communicates with said device.

71. The device defined in claim 70, wherein the remote control device communicates with said device using infrared radiation.

72. The device defined in claim 54, wherein the software module further comprises a voice recognition software module, which receives user input in the form of voice commands, said voice recognition software module converts said voice commands into electronic data and provides the first software playback module with said electronic data to facilitate the playback of media content.

73. A device comprising a processor that controls playback of media content delivered asynchronously from a remote device, wherein the device generates a notification to a user of said device upon receipt of the media content.

74. The device defined in claim 73, wherein the notification is an automatic notification.

75. The device defined in claim 73, wherein the notification is an audio notification.

76. The device defined in claim 73, wherein the notification is in the form of an e-mail.

77. The device defined in claim 73, wherein the playback of the media content is enabled at a predetermined time after the delivery of the media content.

78. The device defined in claim 77, wherein the notification is an automatic notification.

79. The device defined in claim 77, wherein the notification is an audio notification.

80. The device defined in claim 77, wherein the notification is in the form of an e-mail.

81. A device comprising a processor that controls playback of media content delivered asynchronously over a communication channel including a satellite system by a remote device, wherein the playback of the media content is enabled at a predetermined time after the delivery of the media content.

82. A system for implementing a media content delivery and playback scheme, said system comprising:
a communication channel;
a first device that is coupled to said communication channel, said first device including a first processor that controls asynchronous delivery of media content over the communication channel; and
a second device that is coupled to said communication channel, said second device comprising a second processor that controls the playback of media content delivered asynchronously over the communication channel by the first device, wherein the playback of media content is enabled in said second device at a first predetermined time after the delivery of the media content.

83. The system defined in claim 82, wherein the media content is not detectable by a user of the second device until said predetermined time.

84. The system defined in claim 82, wherein the second device initiates a session with the first device at the predetermined time.

85. The system defined in claim 84, wherein the second device initiates the session by making a request for a connection with said first device.

86. The system defined in claim 85, wherein said first device establishes the connection in response to the request.

87. The system defined in claim 86, wherein said first device provides the second device with an indication that a user of the second device is entitled to the media content.

88. The system defined in claim 87, wherein the second device accepts the media content for delivery only if it does not already have the media content.

89. The system defined in claim 82, wherein said first device is a server computer and said second device is a client computer.

90. The system defined in claim 89, wherein said communication channel includes at least a portion of a network.

91. The system defined in claim 90, wherein said network is a local area network.

92. The system defined in claim 90, wherein said network is a wide area network.

93. The system defined in claim 90, wherein said communication channel includes at least a portion of the Internet.

94. The system defined in claim 82, wherein said first device is a server computer.

95. The system defined in claim 94, wherein said second device is a portable device.

96. The system defined in claim 95, wherein said portable device is a wireless device.

97. The system defined in claim 96, wherein said wireless device is a cellular phone.

98. The system defined in claim 95, wherein said communication channel includes a wireless network.

99. The system defined in claim 82, wherein said second device is a portable device.

100. The system defined in claim 99, wherein said portable device is a wireless device.

101. The system defined in claim 82, wherein the delivery ofthe media content from the first device to the second device is controlled in accordance with a digital rights management scheme.

102. A device comprising a processor that controls the delivery of media content over a communication channel to a remote device in one of a first mode and a second mode, wherein the first mode the processor controls the asynchronous delivery of media content over the communication channel to facilitate playback of the media content through the remote device, wherein the second mode the processor controls the synchronous delivery of media content over the communication channel to facilitate the playback of the media content through the remote device.

103. The device defined by claim 102, wherein the playback of the media content is enabled at a predetermined time after the delivery of the media content.

104. The device defined in claim 102, wherein said device delivers the media content.

105. The device defined in claim 102, wherein said communication channel includes a satellite communication channel.

106. The device defined in claim 104, wherein said device is a server computer.

107. The device defined in claim 102, wherein said device is a server computer.

108. The device defined in claim 102, wherein the playback of the media content is controlled in accordance with a digital rights management scheme.

109. The device defined in claim 102, wherein said remote device includes a client computer.

110. The device defined in claim 102, wherein said remote device is a portable device.

111. The device defined in claim 110, wherein said portable device is a wireless device.

112. The device defined in claim 111, wherein said wireless device is a cellular phone.

113. A device comprising a processor that controls playback of media content delivered over a communication channel by a remote device, said processor controlling the playback of media content in one a first mode and a second mode, wherein the first mode the processor controls the playback of media content delivered asynchronously by the remote device, wherein the second mode the processor controls the playback of media content delivered synchronously by the remote device.

114. The device defined in claim 113, wherein the playback of the media content is enabled at a predetermined time after the delivery of the media content.

115. The device defined in claim 113, wherein the media content is not detectable by a user of the device until the predetermined time.

116. A device comprising a processor that controls the delivery of media content over a communication channel to a remote device in one of a first mode and a second mode, wherein the first mode the processor controls the unicast-based delivery of media content over the communication channel to facilitate playback of the media content through the remote device, wherein the second mode the processor controls the multicast-based delivery of media content over the communication channel to facilitate the playback of the media content through the remote device.

117. The device defined by claim 116, wherein the playback of the media content is enabled at a predetermined time after the delivery of the media content.

118. The device defined in claim 116, wherein said device delivers the media content.

119. The device defined in claim 116, wherein said communication channel includes a satellite communication channel.

120. The device defined in claim 118, wherein said device is a server computer.

121. The device defined in claim 116, wherein said device is a server computer.

122. The device defined in claim 116, wherein the playback of the media content is controlled in accordance with a digital rights management scheme.

123. The device defined in claim 116, wherein said remote device includes a client computer.

124. The device defined in claim 116, wherein said remote device is a portable device.

125. The device defined in claim 124, wherein said portable device is a wireless device.

126. The device defined in claim 125, wherein said wireless device is a cellular phone.

127. A device comprising a processor that controls playback of media content delivered over a communication channel by a remote device, said processor controlling the playback of media content in one of a first mode and a second mode, wherein the first mode the processor controls the playback of media content delivered by the remote device via a unicast mode of delivery, wherein the second mode the processor controls the playback of media content delivered by the remote device via a multicast mode of delivery.

128. The device defined in claim 127, wherein the playback of the media content is enabled at a predetermined time after the delivery of the media content.

129. The device defined in claim 127, wherein the media content is not detectable by a user of the device until the predetermined time.

130. A device comprising a processor that controls asynchronous delivery of media content over a communication channel to facilitate playback of the media content through a remote device; wherein said device receives a request for a connection from the remote device; establishes the connection in response to the request, provides the remote device with a first indication that a user of the remote device is entitled to the media content, and receives from the remote device a second indication that the remote device will accept the media content for delivery unless the remote device already has the media content.

131. The device defined in claim 130, wherein the first indication includes a first list of a first group of media content items including at least a first media content item, which is the media content.

132. The device defined in claim 131, wherein the second indication includes a second list of a second group of media content items including at least a second media content item, which is the media content.

133. The device defined in claim 132, wherein the second group of media content items includes a plurality of media content items including at least the second media content item, said second group of media content items being a group of media content items that the remote device will accept for delivery from the device.

134. A device comprising a processor that controls playback of media content delivered asynchronously over a communication channel by a remote device; wherein said device makes a request for a connection to the remote device, receives a connection from the remote device in response to the request, receives a first indication from the remote device that a user of the device is entitled to the media content from the remote device, and provides a second indication to the remote device that said device will accept the media content for delivery unless said device already has the media content.

135. The device defined in claim 134, wherein the first indication includes a first list of a first group of media content items including at least a first media content item, which is the media content.

136. The device defined in claim 135, wherein the second indication includes a second list of a second group of media content items including at least a second media content item, which is the media content.

137. The device defined in claim 136, wherein the second group of media content items includes a plurality of media content items including at least the second media content item, said second group of media content items being a group of media content items that said device will accept for delivery from the remote device.

138. A device comprising a processor that controls playback of media content delivered asynchronously over a communication channel by a remote device, wherein said device is capable of providing an indication to another on behalf of a user of said device, said indication being of a location where the media content may be found.

139. A device comprising a processor that controls playback of media content delivered asynchronously over a communication channel by a remote device, wherein said device is capable of providing a portion of the media content to another on behalf of a user of said device.

140. The device defined in claim 139, wherein the portion of the media content may be provided as an attachment to an e-mail.

141. A computer program product for use in a device having a processor for executing software instructions, said computer program product comprising:
a computer usable medium having computer readable program code means embodied therein for causing the device to control the asynchronous delivery of media content over a communication channel to facilitate playback of the media content through a remote device, the playback of the media content not being enabled until a first predetermined time.

142. A computer program product for use in a device having a processor for executing software instructions, said computer program product comprising:
a computer usable medium having computer readable program code means embodied therein for causing the device to control playback of media content delivered asynchronously over a communication channel by a remote device, the playback of the media content not being enabled until a predetermined time.

143. A method of implementing a media content delivery and playback scheme, said method comprising the steps of:
delivering media content asynchronously via a communication channel for remote playback of the media content, wherein the remote playback of the media content is enabled at a predetermined time after the delivery of the media content.

144. The method defined in claim 143, wherein the media content is not detectable until said predetermined time.

145. The method defined in claim 143, further comprising the steps of:
receiving the media content; and
enabling the playback of the media content at the predetermined time.

146. The method defined in claim 145, further comprising the step of:
conducting the playback of the media content after the step of enabling the playback of the media content at the predetermined time.

147. The method defined in claim 146, wherein the step of conducting comprises the step of displaying the media content.

148. A method of implementing a media content delivery and playback scheme, said method comprising the steps of:
receiving media content which is delivered asynchronously via a communication channel; and
enabling the playback of the media content at a predetermined time after the receipt of the media content.

149. The method defined in claim 148, further comprising the step of detecting said media content at the predetermined time.

150. The method defined in claim 148, further comprising the step of providing a notification of receipt of the media content.
